(19) United States
(12) Patent Application Publication
(10) Pub. No.: US 2008/0002562 A1
(43) Pub. Date: Jan. 3, 2008

(54) WRITE ONCE INFORMATION RECORDING MEDIUM AND DISK APPARATUS

(76) Inventors: Seiji Morita, Yokohama-shi (JP); Koji Takazawa, Tokyo (JP); Kazuyo Umezawa, Yokohama-shi (JP); Naoki Morishita, Yokohama-shi (JP); Naomasa Nakamura, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/768,570

(22) Filed: Jun. 26, 2007

(30) Foreign Application Priority Data
Jun. 30, 2006 (JP) 2006-182812

(51) Int. Cl. G11B 7/24

(52) U.S. Cl. 369/275.4

(57) ABSTRACT

According to one embodiment, in a multilayered write once information recording medium, the light reflectance of a recording mark formed in a first recording film by irradiation with a short-wavelength laser beam is higher than a light reflectance before irradiation with the short-wavelength laser beam, the light reflectance of a recording mark formed in a second recording film by irradiation with the short-wavelength laser beam is higher or lower than a light reflectance before irradiation with the short-wavelength laser beam, and the light reflectance of a recording mark formed in a third recording film, which is arbitrarily formed, by irradiation with the short-wavelength laser beam is higher or lower than a light reflectance before irradiation with the short-wavelength laser beam.

### CROSS-REFERENCE TO RELATED APPLICATIONS

This application is based upon and claims the benefit of priority from Japanese Patent Application No. 2006-182812, filed Jun. 30, 2006, the entire contents of which are incorporated herein by reference.

### BACKGROUND

1. Field

One embodiment of the present invention relates to a write once information recording medium capable of recording/playback of information by using a short-wavelength laser beam such as a blue laser beam, and a display apparatus for playing back the medium.

2. Description of the Related Art

As is well known, the recent spread of personal computers and the like is increasing the importance of digital data storage media. For example, information recording media capable of digital recording/playback of long-time video information and audio information are presently widespread. Also, information recording media for digital recording/playback are beginning to be used in mobile apparatuses such as cell phones.

Many information recording media of this type have disk shapes because disks have a large information recording capacity and a high random accessibility which allows rapid retrieval of desired recorded information. In addition, disks can be easily stored and carried because they are compact and light in weight and also inexpensive.

Presently, so-called optical disks capable of recording and playing back information in a non-contact state by irradiation with a laser beam are most frequently used as disk-like information recording media. These optical disks mainly comply with the CD (Compact Disk) standards or DVD (Digital Versatile Disk) standards, and these two standards have compatibility.

The optical disks are classified into three types: read-only optical disks incapable of information recording such as a CD-DA (Digital Audio), CD-ROM (Read-Only Memory), DVD-V (Video), and DVD-ROM; write once optical disks capable of writing information once such as a CD-R (Recordable) and DVD-R; and rewritable optical disks capable of rewriting information any number of times such as a CD-RW (ReWritable) and DVD-RW.

Of the optical disks capable of recording, the write once optical disks using organic dyes in recording layers are most popular because the manufacturing cost is low. This is so because users rarely rewrite recorded information with new information when using optical disks having information recording capacities exceeding 700 MB (Mega Bytes), so it is only necessary to record information just once.

In a write once optical disk using an organic dye in a recording layer, a recording region (track) defined by a groove is irradiated with a laser beam to heat a resin substrate to its glass transition point Tg or more, thereby causing a photochemical reaction of an organic dye film in the groove and producing a negative pressure. Consequently, the resin substrate deforms in the groove to form a recording mark.

A representative example of an organic dye used in a CD-R for which the wavelength of a recoding/playback laser beam is about 780 nm is a phthalocyanine-based dye such as IGRAPHOR Ultragreen MX manufactured by Ciba Specialty Chemicals. A representative example of an organic dye used in a DVD-R for which the wavelength of a recoding/playback laser beam is about 650 nm is an azo metal complex-based dye manufactured by MITSUBISHI KAGAKU MEDIA.

For the next-generation optical disks which achieve high-density, high-performance recording/playback compared to the present optical disks, a blue laser beam having a wavelength of about 405 nm is used as a recording/playback laser beam. Unfortunately, no organic dye material capable of obtaining practically satisfactory recording/playback characteristics by using this short-wavelength light has been developed yet.

That is, the present optical disks which perform recording/playback by using an infrared laser beam or red laser beam use organic dye materials having absorption peaks at wavelengths shorter than the wavelengths (780 and 650 nm) of the recording/playback laser beams. Accordingly, the present optical disks realize so-called H(High)-to-L(Low) characteristics by which the light reflectance of a recording mark formed by irradiation with a laser beam is lower than a light reflectance before the laser beam irradiation.

By contrast, when performing recording/playback by using a blue laser beam, an organic dye material having an absorption peak at a wavelength shorter than the wavelength (405 nm) of the recording/playback laser beam is inferior not only in stability to ultraviolet radiation or the like and storage durability but also in stability to heat. This lowers the contrast and resolution of a recording mark.

Also, the blur of a recording mark often enlarges to have an effect on adjacent tracks and easily deteriorates the cross write characteristic. In addition, the recording sensitivity lowers, and this makes it impossible to obtain a high playback signal S/N (Signal-to-Noise) ratio and low bit error rate.

Note that when no information is recorded on adjacent tracks, a practical recording sensitivity is sometimes obtained. If information is recorded on adjacent tracks, however, cross write to the adjacent tracks increases, and this decreases the playback signal S/N ratio and increases the bit error rate, so no practically suitable level is achieved.

For example, as described in Jpn. Pat. Appln. KOKAI Publication No. 2002-74740, there is an optical recording medium in which an organic dye compound contained in a recording layer has an absorption peak at a wavelength longer than the wavelength of a write beam. However, the arrangement of this optical recording medium for improving the performance of the optical disk itself is not improved at all.

Recently, a double-layer DVD-R is proposed for the demand for increasing the capacity of the write once recording disk. The double-layer DVD-R is a disk given a large capacity of 8.5 GB by forming two recording layers in the DVD-R, and has two organic dye recording films. The disk configuration has a forward stacked structure or reverse stacked structure. When using organic dye layers as recording films in the reverse stacked structure, first and second layers are formed on different substrates and adhered by an adhesive such that the two substrates are outside. The first layer is formed by sequentially stacking the substrate, the organic dye layer, and a reflecting film, and the second layer is formed by sequentially stacking the substrate, a reflecting film, and the organic dye layer. Therefore, the organic dye layers and reflecting films are stacked in reverse orders. Since, however, interference occurs between the organic dye layer as the second layer and the adhesive, a barrier layer (protective layer) made of a dielectric material is formed on the organic dye layer as the second layer, and the adhesive is applied via this barrier layer. The formation of the barrier layer requires an additional manufacturing facility and hence increases the cost, and often lowers the cycle time of mass-production. It is also difficult to obtain good recording/playback characteristics as disk performance.

Accordingly, the forward stacked structure is presumably more suitable. However, the manufacturing process is very complicated, and a cycloolefin polymer (COP) substrate must be used as a transfer stamper of the second layer. These factors increase the cost and decrease the yield. This manufacturing method is limited to a double-layer DVD-R which performs recording/playback by a red laser, and inapplicable to the manufacturing process of a double-layer HD DVD-R having a higher density.

When forming a recording disk in a triple-layer structure to increase its capacity, it is difficult to implement these techniques. The reflectance of each recording layer tends to decrease to 1% or less. Especially, when forming a recording disk in a triple-layer structure with an L(Low)-to-H(High) characteristics by which the reflectance of a mark increases after recording, the reflectance becomes 1% or less in a structure of three or more layers because of low reflectance before recording. Hence, it becomes difficult not only to read a recording signal by an optical disk drive but also to perform focusing or tracking.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic view showing the sectional structure of an example of a write once information recording medium according to the present invention;

FIG. 2 is a schematic view showing the procedure of a method of manufacturing the example of the write once information recording medium according to the present invention;

FIG. 3 is a schematic view showing the sectional structure of another example of a write once information recording medium according to the present invention;

FIG. 4 is a schematic view showing the procedure of a method of manufacturing a triple-layer write once information recording medium 117 shown in FIG. 3.

FIG. 5 is a schematic view showing the procedure of a method of manufacturing the triple-layer write once information recording medium 117 shown in FIG. 3.

FIG. 6 is a view showing the characteristics of organic dye materials usable as an L-to-H type organic dye layer;

FIGS. 7A to 7C are graphs showing the relationship between the laser beam wavelength and absorbance for each dye;

FIGS. 8A and 8B are graphs showing the relationship between the laser beam wavelength and absorbance for each dye;

FIG. 9 is a view for explaining a normalized wobble amplitude NWS used to evaluate the write once information recording medium;

FIGS. 10A and 10B are views for explaining the configuration of wobble address data of the example of the write once information recording medium according to the present invention;

FIGS. 11A to 11E are views for explaining the types of wobble data units WDU of the example of the write once information recording medium according to the present invention;

FIGS. 12A and 12B are views for explaining the configuration of the wobble address data of the example of the write once information recording medium according to the present invention;

FIG. 13 is a view for explaining the type of wobble of the example of the write once information recording medium according to the present invention;

FIGS. 14A to 14D are views for explaining the physical segment configuration of the wobble address data of the write once information recording medium;

FIG. 15 is a block diagram showing an outline of the arrangement of a disk apparatus for playing back the example of the write once information recording medium according to the present invention;

FIG. 16 is a view for explaining the relationship between a groove and land in the example of the write once information recording medium according to the present invention;

FIGS. 17A and 17B are views for explaining the wobble of groove tracks in the example of the write once information recording medium according to the present invention; and

FIG. 18 is a waveform diagram showing an example of a signal to be recorded on the write once information recording medium in order to conduct evaluation tests for recording/playback evaluation.

### DETAILED DESCRIPTION

Various embodiments according to the invention will be described hereinafter with reference to the accompanying drawings. In general, according to one embodiment of the invention, in a multilayered write once information recording medium, the light reflectance of a recording mark formed in a first recording film by irradiation with a short-wavelength laser beam is higher than a light reflectance before irradiation with the short-wavelength laser beam, the light reflectance of a recording mark formed in a second recording film by irradiation with the short-wavelength laser beam is higher or lower than a light reflectance before irradiation with the short-wavelength laser beam, and the light reflectance of a recording mark formed in a third recording film, which is arbitrarily formed, by irradiation with the short-wavelength laser beam is higher or lower than a light reflectance before irradiation with the short-wavelength laser beam.

The present invention is roughly classified into the first to eighth aspects.

An invention according to the first aspect is a write once information recording medium having two or more recording layers, and basically comprising a transparent resin substrate having a groove and land with a concentric or spiral shape, a first recording film formed on the groove and land of the transparent resin substrate, an interlayer made of a transparent resin material having a groove and land with the above shape, and a second recording film formed on the groove and land of the interlayer. In this write once information recording medium, a recording mark is formed by irradiation with a short-wavelength laser beam, and the groove wobbles within a predetermined amplitude range. In addition, the light reflectance of the recording mark formed in the first recording film by irradiation with the short-wavelength laser beam is higher than a light reflectance before irradiation with the short-wavelength laser beam, and the light reflectance of the recording mark formed in the second recording film by irradiation with the short-wavelength laser beam is lower than a light reflectance before irradiation with the short-wavelength laser beam.

Write once information recording media according to the second and third aspects are application examples of the write once information recording medium according to the first aspect, and have three or more recording layers. These media comprise a second interlayer formed on the second recording film and made of a transparent resin material having a groove and land with a concentric or spiral shape, and a third recording film formed on the groove and land of the second interlayer, and have the following characteristics in accordance with light reflectance of a recording mark in the third recording film.

In the write once information recording medium according to the second aspect, the light reflectance of the recording mark formed in the third recording film by irradiation with the short-wavelength laser beam is higher than a light reflectance before irradiation with the short-wavelength laser beam.

In the write once information recording medium according to the third aspect, the light reflectance of the recording mark formed in the third recording film by irradiation with the short-wavelength laser beam is lower than the light reflectance before irradiation with the short-wavelength laser beam.

An invention according to the fourth aspect is a write once information recording medium having three or more recording layers, and characterized by comprising a transparent resin substrate having a concentric or spiral groove and land, a first recording film formed on the groove and land of the transparent resin substrate, a first interlayer formed on the first recording film and made of a transparent resin material having a concentric or spiral groove and land, a second recording film formed on the groove and land of the first interlayer, a second interlayer formed on the second recording film and made of a transparent resin material having a concentric or spiral groove and land, and a third recording film formed on the groove and land of the second interlayer, wherein a recording mark is formed in the first, second, and third recording films by irradiation with a short-wavelength laser beam, the light reflectance of the recording mark formed in the first recording film by irradiation with the short-wavelength laser beam is higher than a light reflectance before irradiation with the short-wavelength laser beam, the light reflectance of the recording mark formed in the second recording film by irradiation with the short-wavelength laser beam is higher than a light reflectance before irradiation with the short-wavelength laser beam, the light reflectance of the recording mark formed in the third recording film by irradiation with the short-wavelength laser beam is lower than a light reflectance before irradiation with the short-wavelength laser beam, and the groove wobbles within a predetermined amplitude range.

Inventions according to the fifth, sixth, seventh, and eighth aspects are respectively disk apparatuses for playing back the write once information recording media according to the first, second, third, and fourth aspects.

The present invention will be explained in more detail below with reference to the accompanying drawing.

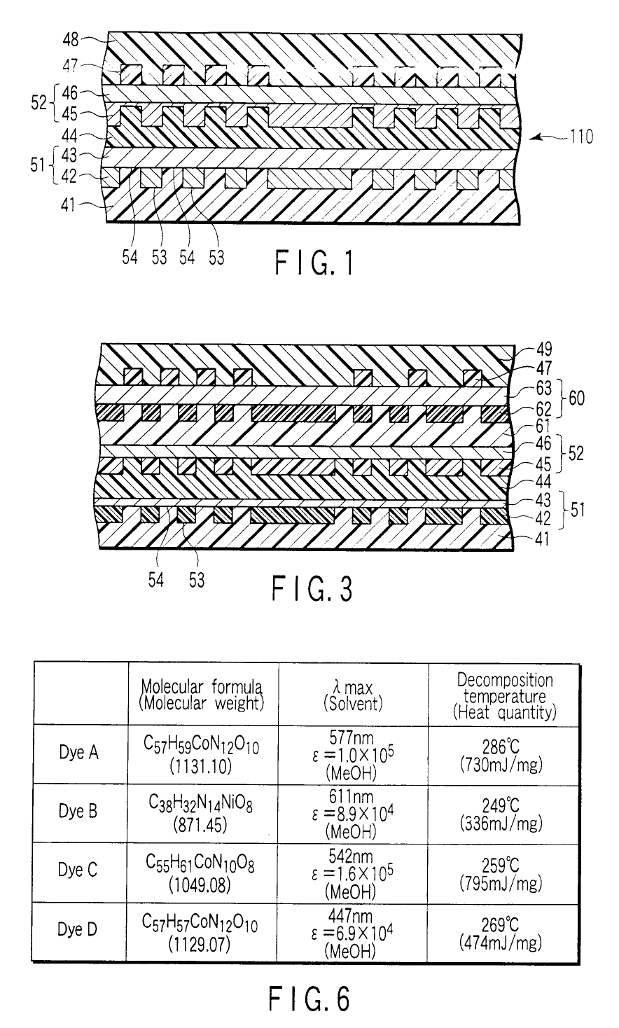

FIG. 1 is a schematic view showing the sectional structure of an example of a write once information recording medium according to the present invention.

As shown in FIG. 1, a double-layer write once information recording medium 110 comprises, on a first substrate 41 made of a transparent resin having concentric or spiral grooves and lands, a first recording film 51 formed on grooves 53 and lands 54 of the first substrate 41, an interlayer 44 made of a transparent resin material such as an ultraviolet-curing resin having concentric or spiral grooves 53 and lands 54, and a second recording film 52 formed on the grooves 53 and lands 54 of the interlayer 44.

The first recording film 51 comprises a first organic dye layer 42 formed on the grooves 53 and lands 54 of the transparent resin substrate 41, and a semitransparent layer 43 formed on the first organic dye layer 42 and made of, e.g., a silver alloy. The second recording film 52 comprises a second organic dye layer 45 formed on the interlayer 44, and a reflecting layer 46 made of, e.g., a silver alloy.

Also, a second substrate 48 made of a transparent resin or the like is formed on the silver alloy reflecting layer 46 via an adhesive layer 47.

A method of manufacturing the double-layer write once information recording medium of the present invention will be described below.

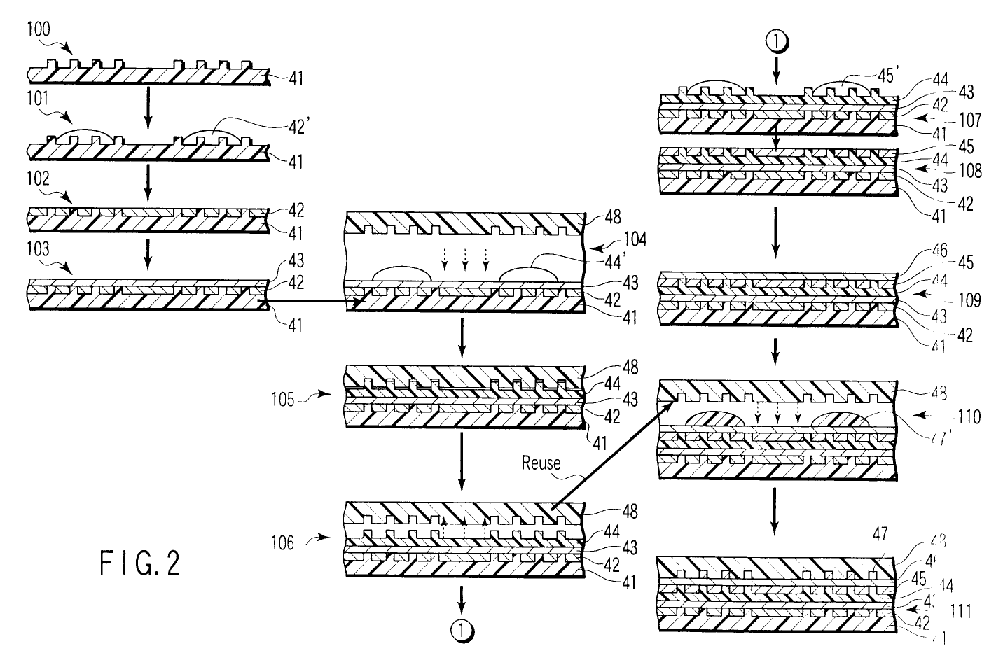

FIG. 2 is a schematic view showing the procedure of the method of manufacturing the example of the double-layer write once information recording medium described above.

Reference numerals 100 to 111 in FIG. 2 denote models for explaining steps of manufacturing the example of the double-layer write once information recording medium.

First, in a step denoted by 100, an L0 polycarbonate substrate 41 obtained by injection molding of an L0 Ni stamper obtained in a mastering step is prepared, in order to form a first recording film (L0) 51. An L0 organic dye material 42′ is applied on the substrate 41 as indicated by 101, and spread by spin coating and dried as indicated by 102, thereby obtaining a first organic dye layer 42.

Then, in a step denoted by 103, a semitransparent layer 43 is formed by sputtering a silver alloy or the like, thereby obtaining a stacked structure of the first organic dye layer 42 and semitransparent layer 43, as a first recording film (L0) 51, on the substrate 41.

Meanwhile, a second recording film (L1) Ni stamper (mother stamper) obtained in a mastering step is injection-molded to prepare an L1 polycarbonate substrate 48.

An ultraviolet-curing resin 44′ is applied as indicated by 104 on the semitransparent layer 43 of the stacked structure obtained in the step denoted by 103, and spread by spin coating to form an ultraviolet-curing resin layer 44.

Subsequently, as indicated by 105, the L1 polycarbonate substrate 48 is pressed against the ultraviolet-curing resin 44 and temporarily adhered by ultraviolet radiation. Note that the spin conditions are adjusted to make the thickness of the ultraviolet-curing resin 44′ uniform.

After that, as indicated by 106, the L1 polycarbonate substrate 48 is removed from the cured ultraviolet-curing resin 44.

Then, an L1 organic dye material 45′ is applied on the surface of the ultraviolet-curing resin layer 44 as indicated by 107, and spread by spin coating and dried to form a second organic dye layer 45 as indicated by 108.

Furthermore, a reflecting layer 46 is formed by sputtering, e.g., a silver alloy as indicated by 109, thereby obtaining a second recording film (L1) having a stacked structure of the second organic dye layer 45 and reflecting layer 46.

After that, an adhesive 47′ is applied on the reflecting layer 46 as indicated by 110. In addition, the polycarbonate substrate 48 injection-molded as the L1 transfer stamper in the step denoted by 106 is adhered via an adhesive layer 47, thereby obtaining a double-layer write once information recording medium having the arrangement denoted by 110.

FIG. 3 is a schematic view showing the sectional structure of another example of the write once information recording medium according to the present invention.

As shown in FIG. 3, this triple-layer write once information recording medium is represented by a model 117 and has the same arrangement as FIG. 1 except that a second substrate 49 is used instead of the second substrate 48, and a second interlayer 61 and a third recording layer 60 including a third organic dye layer 62 and a reflecting layer 63 made of, e.g., a silver alloy are formed between the silver alloy reflecting layer 46 and the adhesive layer 47 and second substrate 49.

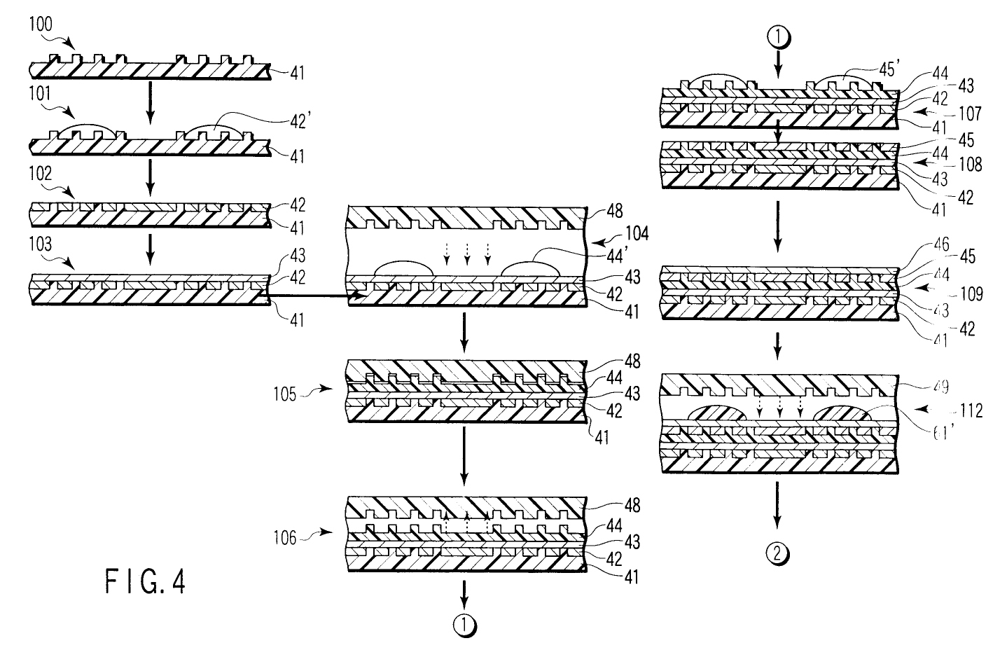

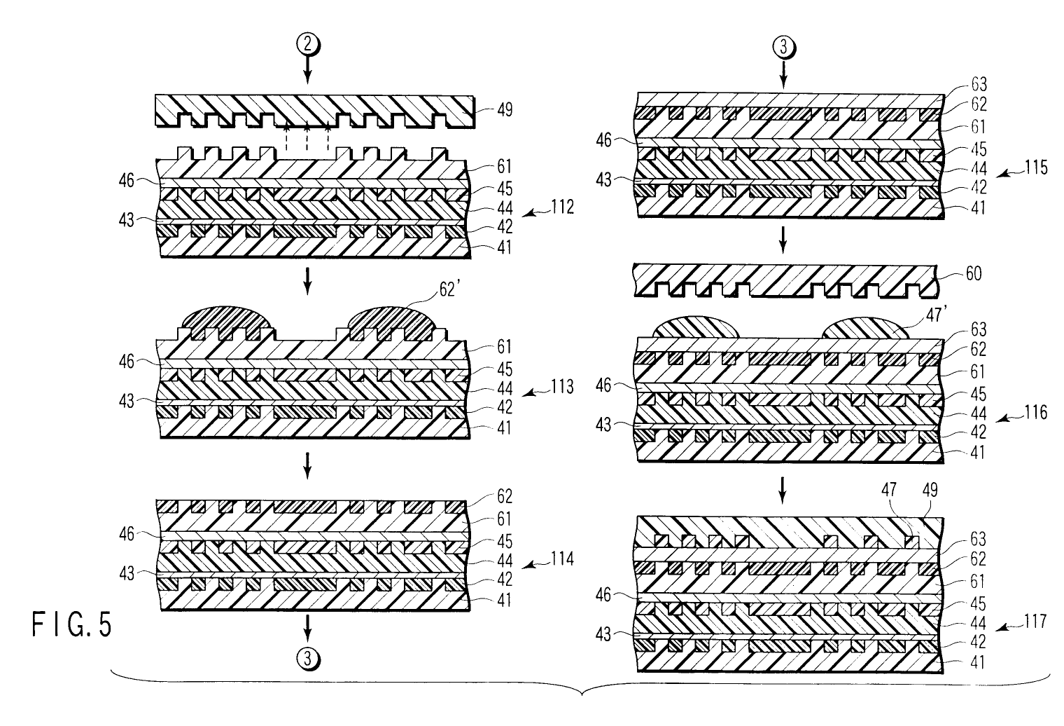

FIGS. 4 and 5 are schematic views showing the procedure of a method of manufacturing the write once information recording medium 117 shown in FIG. 3.

Reference numerals 100 to 109 and 112 to 117 in FIGS. 4 and 5 denote models for explaining steps of manufacturing an example of the triple-layer write once information recording medium described above.

As shown in FIG. 4, the manufacturing steps of the triple-layer write once information recording medium up to steps represented by the models 100 to 109 are the same as those shown in FIG. 2. After that, an ultraviolet-curing resin 61′ is applied instead of an adhesive onto a reflecting layer 46 and, as indicated by 112, an L2 polycarbonate substrate 49 injection-molded as an L2 transfer stamper is pressed against the ultraviolet-curing resin 61′ and temporarily adhered by ultraviolet radiation. Note that the spin conditions are adjusted to make the thickness of the ultraviolet-curing resin 61′ uniform.

After that, as indicated by 112, the L2 polycarbonate substrate 49 is removed from a cured ultraviolet-curing resin 61.

Then, an L2 organic dye material 62′ is applied on the surface of the ultraviolet-curing resin layer 61 as indicated by 113, and spread by spin coating and dried to form a second organic dye layer 62 as indicated by 114.

Furthermore, a reflecting layer 63 is formed by sputtering, e.g., a silver alloy as indicated by 115, thereby obtaining a third recording film (L2) having a stacked structure of the third organic dye layer 62 and reflecting layer 63.

After that, an adhesive 47′ is applied on the reflecting layer 63 as indicated by 116. In addition, the polycarbonate substrate 49 molded as the L2 transfer stamper in the step denoted by 112 is adhered via an adhesive layer 47, thereby obtaining a triple-layer write once information recording medium having the arrangement denoted by 117.

The present invention can use, as the ultraviolet-curing resin, a material which easily removes from the polycarbonate substrate and sticks to the Ag layer or Ag alloy layer. The use of this ultraviolet-curing resin facilitates transfer of the land-groove pattern of L1 to the ultraviolet-curing resin layer 44.

It is only necessary to use one type of ultraviolet-curing resin as described above, and L1 and L2 can be formed without using any conventional vacuum bonding step. This simplifies the bonding step and the facility for the step.

In addition, this ultraviolet-curing resin readily removes from the polycarbonate substrate, so the substrate hardly warps. Consequently, a favorable write once information recording medium having a push-pull signal modulation degree of 0.26 or more is obtained.

The push-pull signal modulation degree is preferably as large as possible. Also, the warpage (tilt angle) is preferably as small as possible.

The ultraviolet-curing resin usable in an embodiment of the present invention is a polymer material containing carbon, hydrogen, nitrogen, and oxygen as main components. The oxygen ratio in this polymer material can be 11 atm % or more.

The ultraviolet-curing resin containing carbon, hydrogen, nitrogen, and oxygen as main components and having an oxygen ratio of 11 atm % or more easily removes from the polycarbonate substrate and sticks to the Ag layer or Ag alloy layer. The oxygen ratio of the ultraviolet-curing resin usable in some embodiment of the present invention is 11 to 14 atm %.

The “main component” herein mentioned is an element having a relatively high atomic ratio among elements forming a polymer material, e.g., an element having either the highest atomic ratio or an atomic ratio close to the highest atomic ratio.

The ultraviolet-curing resin material used in the present invention is formed by mixing a monomer, oligomer, adhesive, and polymerization initiator. It is also possible to mix a plurality of types of monomers and a plurality of types of oligomer materials.

The following materials are used as the monomer material.

.Acrylates

Bisphenol A-ethylene oxide modified diacrylate (BPEDA)

Dipentaerythritol hexa (penta) acrylate (DPEHA)

Dipentaerythritolmonohydroxy pentaacrylate (DPEHPA)

Dipropyleneglycol diacrylate (DPGDA)

Ethoxylated trimethylolpropane triacrylate (ETMPTA)

Glycerinpropoxy triacrylate (GPTA)

4-hydroxybutyl acrylate (HBA)

1,6-hexanediol diacrylate (HDDA)

2-hydroxyethyl acrylate (HEA)

2-hydroxypropyl acrylate (HPA)

Isobornyl acrylate (IBOA)

Polyethyleneglycol diacrylate (PEDA)

Pentaerythritol triacrylate (PETA)

Tetrahydrofulfuryl acrylate (THFA)

Trimethylolpropane triacrylate (TMPTA)

Tripropyleneglycol diacrylate (TPGDA)

.Methacrylates

Tetraethyleneglycol dimethacrylate (TEDMA)

Alkyl methacrylate (AKMA)

Allyl methacrylate (AMA)

1,3-butyleneglycol dimethacrylate (BDMA)

n-butyl methacrylate (BMA)

Benzyl methacrylate (BZMA)

Cyclohexyl methacrylate (CHMA)

Diethyleneglycol dimethacrylate (DEGDMA)

2-ethylhexyl methacrylate (EHMA)

Glycidyl methacrylate (GMA)

1,6-hexanediol dimethacrylate (HDDMA)

2-hydroxyethyl methacrylate (2-HEMA)

Isobornyl methacrylate (IBMA)

Lauryl methacrylate (LMA)

Phenoxyethyl methacrylate (PEMA)

t-butyl methacrylate (TBMA)

Tetrahydrofurfuryl methacrylate (THFMA)

Trimethylolpropane trimethacrylate (TMPMA)

Particularly favorable examples are tricyclodecanedimethanol diacrylate (A-DCP) represented by formula (A1) below, isobornyl acrylate (IBOA) represented by formula (A2) below, tripropyleneglycol diacrylate (TPGDA) represented by formula (A3) below, dipropyleneglycol diacrylate (DPGDA) represented by formula (A4) below, neopentylglycol diacrylate (NPDA) represented by formula (A5) below, ethoxylated isocyanuric triacrylate (TITA) represented by formula (A6) below, 2-hydroxypropyl diacrylate (HPDA) represented by formula (A7) below, acetalglycol diacrylate (AGDA) represented by formula (A8) below, ditrimethylolpropane tetraacrylate (DTTA) represented by formula (A9) below, ethoxylated 2-mol bisphenol A dimethyl acrylate (EO2BDMA) represented by formula (A10) below, and ethoxylated 3-mol bisphenol A dimethyl acrylate (EO3BMA) represented by formula (A11) below.

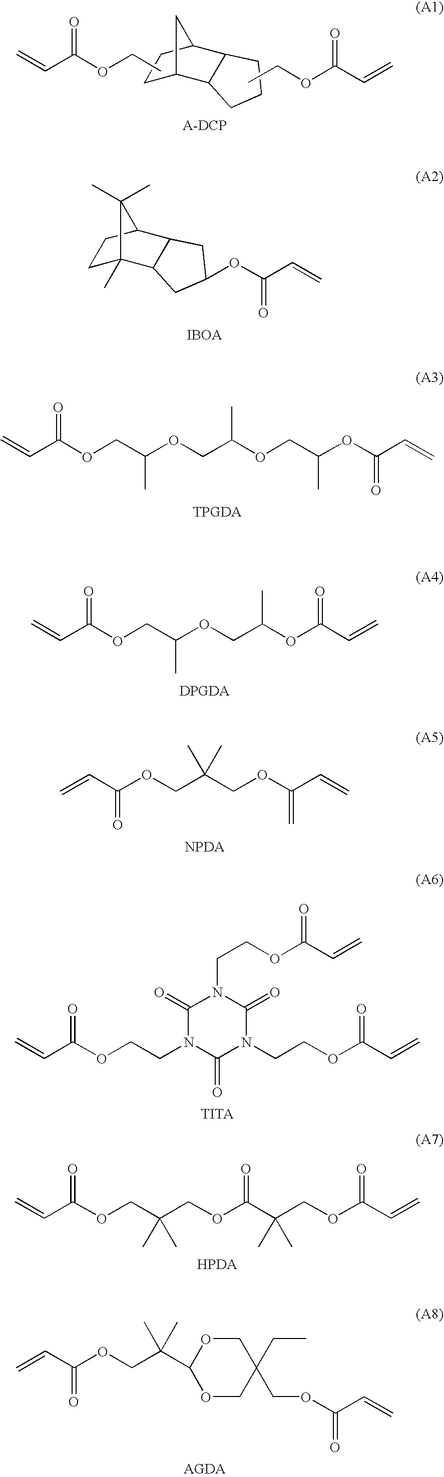

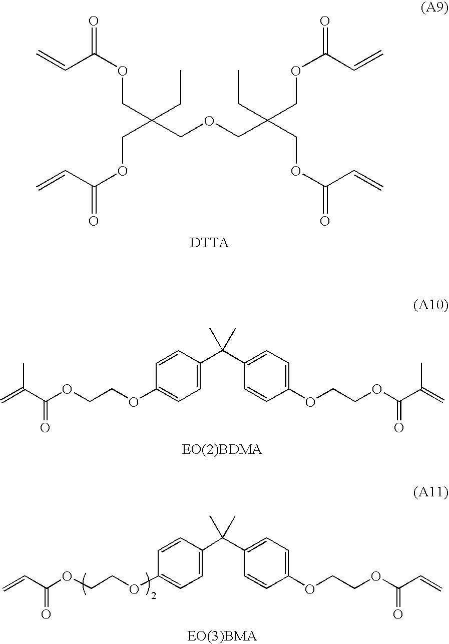

As the oldigomer material, it is possible to use an urethane acrylate-material represented by formula (B1) below, e.g., polyurethane diacrylate (PUDA), or polyurethan hexaacrylate (PUHA) represented by formula (B2) below. Other examples are polymethyl methacrylate (PMMA), polymethyl methacrylate fluoride (PMMA-F), polycarbonate diacrylate, and methyl metharylate polycarbonate fluoride (PMMA-PC-F).

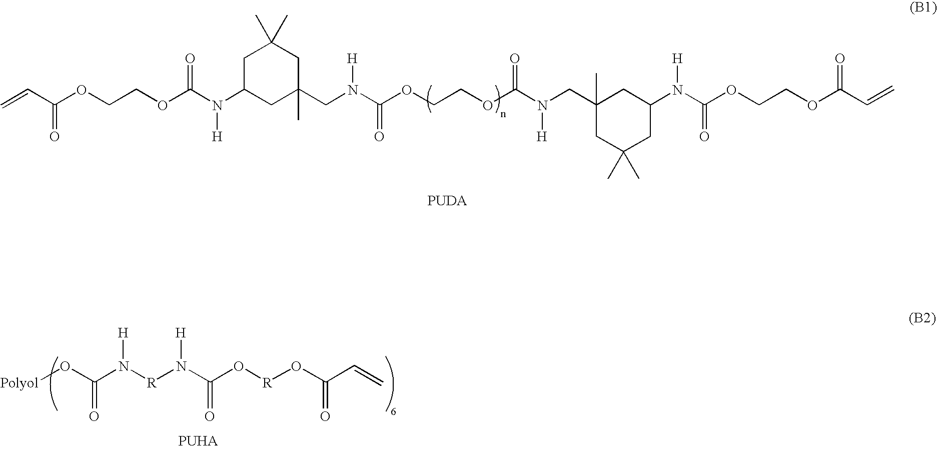

An acrylate phosphate-based material is used as the adhesive. Examples are materials represented by formulas (P1), (P2), and (P3) below.

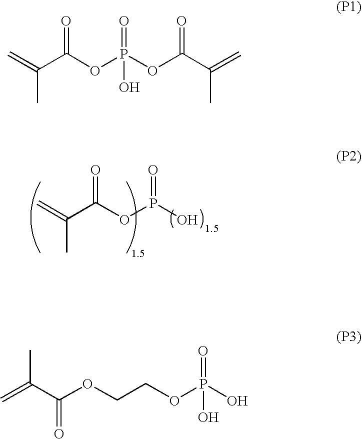

As the polymerization initiator, it is possible to use, e.g., IRGACURE 184 represented by formula (B1) below manufactured by Ciba Specialty Chemicals, or DAROCUR 1173 represented by formula (B2) below manufactured also by Ciba Specialty Chemicals.

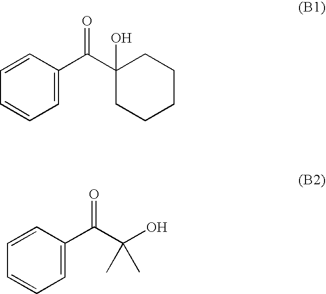

This ultraviolet-curing resin material has a large effect on the coating properties of the L1 and L2 dyes, and hence has a large effect on the push-pull signal modulation degree of L1.

The ultraviolet-curing resin material also has an influence on the warpage of the L0 substrate.

The push-pull signal modulation degree is preferably as large as possible. In one embodiment of the invention, the push-pull signal modulation degree is at least 0.26 or more. The warpage (tilt angle) is preferably as small as possible.

Ultraviolet-curing resin material samples 1 to 36 were obtained by using monomers and oligomers shown in Table 1 below, and mixing the monomers and oligomers, additives, and polymerization initiators by combining them as shown in Tables 2 to 5 below. Tables 3 and 5 also show the oxygen content ratios of these materials and the push-pull signal modulation degrees and tilt angles when the materials were used.

TABLE 1

| | C | H | O | N | Total | CHN/O | O/CHN | O/CHON |
|---|---|---|---|---|---|---|---|---|
| ADGA | 17 | 26 | 6 | 0 | 49 | 7.166666667 | 0.139534884 | 12.24489796 |
| IBOA | 13 | 20 | 2 | 0 | 35 | 16.5 | 0.060606061 | 5.714285714 |
| TPGDA | 15 | 24 | 6 | 0 | 45 | 6.5 | 0.153846154 | 13.33333333 |
| TITA | 18 | 23 | 9 | 3 | 53 | 4.888888889 | 0.204545455 | 16.98113208 |
| A-DCP | 18 | 24 | 4 | 0 | 46 | 10.5 | 0.095238095 | 8.695652174 |
| PUDA (n = 5) | 44 | 74 | 12 | 4 | 134 | 10.16666667 | 0.098360656 | 8.955223881 |
| PUHA | 42 | 54 | 36 | 12 | 144 | 3 | 0.333333333 | 25 |
| EO2BDMA | 27 | 32 | 6 | 0 | 65 | 9.833333333 | 0.101694915 | 9.230769231 |
| EO3BMA | 27 | 32 | 7 | 0 | 66 | 8.428571429 | 0.118644068 | 10.60606061 |
| DTTA | 24 | 34 | 9 | 0 | 67 | 6.444444444 | 0.155172414 | 13.43283582 |
| NPDA | 11 | 16 | 4 | 0 | 31 | 6.75 | 0.148148148 | 12.90322581 |
| HPDA | 16 | 24 | 6 | 0 | 46 | 6.666666667 | 0.15 | 13.04347826 |

TABLE 2

| | | Oligomer or | | | |
|---|---|---|---|---|---|
| | Monomer | monomer | Additive 1 | Additive 2 | Additive 3 |
| Sample 1 | AGDA (92) | | | | |
| Sample 2 | A-DCP (90.5) | | P2 (0.5) | | |
| Sample 3 | IBOA (57) | PUDA (38.3) | P3 (0.1) | PA (0.6) | |
| Sample 4 | IBOA (26) | PUDA (43.9) | TPGDA (26) | P3 (0.1) | |
| Sample 5 | TPGDA (10.8) | EO2BDMA (85) | P3 (0.2) | | |
| Sample 6 | TPGDA (9.8) | EO2BDMA (70) | EO3BMA (15) | P3 (0.2) | |
| Sample 7 | IBOA (50) | TITA (6) | PUHA (38.9) | P3 (0.1) | |
| Sample 8 | IBOA (32.9) | TPGDA (17) | PUHA (23) | PUDA (23) | P3 (0.1) |
| Sample 9 | IBOA (50) | PUHA (18.1) | PUDA (27.7) | P3 (0.1) | |
| Sample 10 | IBOA (51) | PUHA (28) | PUDA (16.9) | P3 (0.1) | |
| Sample 11 | IBOA (50) | PUHA (35) | PUDA (10.9) | P3 (0.1) | |
| Sample 12 | ADGA (97) | | | | |
| Sample 13 | ADGA (96) | | | | |
| Sample 14 | ADGA (86) | TPGDA (9.9) | | P3 (0.1) | |
| Sample 15 | ADGA (83) | IBOA (10) | | | |
| Sample 16 | ADGA (83) | IBOA (9.9) | | P3 (0.1) | |
| Sample 17 | ADGA (62) | IBOA (12) | PUDA (19) | P3 (0.1) | |
| Sample 18 | ADGA (73) | IBOA (9.9) | PUDA (10) | P3 (0.1) | |

TABLE 3

| | | | Push- | | |
|---|---|---|---|---|---|
| | | | pull | Radial | Total |
| | Hardener | O/(CHON) | signal | tilt (°) | evaluation |
| Sample 1 | Irg184 (8) | 12.2 | 0.31 | 2.6 | ◯ |
| Sample 2 | Irg184 (9) | 8.7 | 0.06 | 1 | Δ |
| Sample 3 | Dar1173 (4) | 6.686993603 | 0.07 | 0.8 | Δ |
| Sample 4 | Dar1173 (4) | 5.417057569 | 0.07 | 0 | Δ |
| Sample 5 | Dar1173 (4) | 9.286153846 | 0.13 | 2.5 | Δ |
| Sample 6 | Dar1173 (5) | 9.359114219 | 0.14 | 2.5 | Δ |
| Sample 7 | Irg184 (5) | 13.60101078 | 0.27 | 2.5 | ◯ |
| Sample 8 | Irg184 (4) | 11.95636816 | 0.26 | 2.5 | ◯ |
| Sample 9 | Irg184 (4.1) | 9.862739872 | 0.22 | 2.5 | Δ |
| Sample 10 | Irg184 (4) | 11.42771855 | 0.26 | 2.5 | ◯ |
| Sample 11 | Irg184 (4) | 12.58326226 | 0.27 | 2.5 | ◯ |
| Sample 12 | Irg184 (3) | 11.87755102 | 0.26 | 2.5 | ◯ |
| Sample 13 | Dar1173 (4) | 11.75510204 | 0.293 | 2.35 | ◯ |
| Sample 14 | Dar1173 (4) | 11.85061224 | 0.281 | 2.03 | ◯ |
| Sample 15 | Irg184 (7) | 10.73469388 | 0.288 | 1.77 | ◯ |
| Sample 16 | Irg184 (7) | 10.72897959 | 0.267 | 1.71 | ◯ |
| Sample 17 | Irg184 (6.9) | 9.979043558 | 0.24 | 1.85 | Δ |
| Sample 18 | Irg184 (7) | 10.40001218 | 0.289 | 1.78 | ◯ |

TABLE 4

| | | Oligomer or | | | |
|---|---|---|---|---|---|
| | Monomer | monomer | Additive 1 | Additive 2 | Additive 3 |
| Sample 19 | ADGA (62) | IBOA (12) | PUDA (19) | P3 (0.1) | |
| Sample 20 | ADGA (23.7) | IBOA (35) | PUHA (37.5) | P3 (0.1) | |
| Sample 21 | TITA (12.4) | IBOA (43.3) | PUHA (37.5) | P3 (0.1) | |
| Sample 22 | ADGA (67) | IBOA (25.9) | | P3 (0.1) | |
| Sample 23 | ADGA (84) | HPDA (10) | | P3 (0.1) | |
| Sample 24 | IBOA (25) | HPDA (24) | PUHA (44.9) | P3 (0.1) | |
| Sample 25 | IBOA (25) | HPDA (34) | PUHA (34.9) | P3 (0.1) | |
| Sample 26 | HPDA (54.9) | DTTA (5) | PUHA (34) | P3 (0.1) | |
| Sample 27 | HPDA (54.9) | DTTA (10) | PUHA (29) | P3 (0.1) | |
| Sample 28 | HPDA (60) | DTTA (13.7) | PMMA-F (20.2) | P3 (0.1) | |
| Sample 29 | ADGA (80) | DTTA (13.9) | | P3 (0.1) | |
| Sample 30 | IBOA (20) | HPDA (25.9) | DTTA (10) | PUHA (28) | PMMA (10) |
| Sample 31 | HPDA (45.9) | DTTA (10) | PUHA (28) | PMMA (10) | P3 (0.1) |
| Sample 32 | IBOA (15) | ADGA (53.9) | DTTA (14) | PMMA (11) | P3 (0.1) |
| Sample 33 | IBOA (15) | ADGA (50.9) | DTTA (17) | PMMA (11) | P3 (0.1) |
| Sample 34 | TPGDA (50) | TITA (6) | PUHA (38.9) | P3 (0.1) | |
| Sample 35 | ADGA (86) | TPGDA (10) | | | |
| Sample 36 | ADGA (93) | | | | |

TABLE 5

| | | | | Push-pull | Radial | Total |
|---|---|---|---|---|---|---|
| | Hardener | | O/(CHON) | signal | tilt (°) | evaluation |
| Sample 19 | Irg184 (4) | Dar1173 (2.9) | 9.979043558 | 0.23 | 2.1 | Δ |
| Sample 20 | Irg184 (6) | | 14.27704082 | 0.318 | 3.1 | Δ |
| Sample 21 | Irg184 (6.7) | | 13.95494609 | 0.308 | 2.9 | Δ |
| Sample 22 | Irg184 (7) | | 9.684081633 | 0.22 | 1.27 | Δ |
| Sample 23 | Dar1173 (5.9) | | 11.59006211 | 0.3 | 2.5 | ◯ |
| Sample 24 | Irg184 (6) | | 15.78400621 | 0.36 | 4.2 | Δ |
| Sample 25 | Irg184 (6) | | 14.58835404 | 0.34 | 3.2 | Δ |
| Sample 26 | Irg184 (6) | | 16.33251136 | 0.35 | 4.3 | Δ |
| Sample 27 | Irg184 (6) | | 15.75415315 | 0.34 | 3 | Δ |
| Sample 28 | Irg184 (6) | | 9.001168073 | 0.21 | 1.84 | Δ |
| Sample 29 | Irg184 (6) | | 11.66308255 | 0.39 | 2.54 | ⊚ |
| Sample 30 | P3 (0.1) | Irg184 (6) | 12.86440159 | 0.3 | 2.49 | ◯ |
| Sample 31 | Irg184 (6) | | 14.3302401 | 0.35 | 2.54 | ◯ |
| Sample 32 | Irg184 (6) | | 9.337739872 | 0.19 | 2.5 | Δ |
| Sample 33 | Irg184 (6) | | 9.373378008 | 0.15 | 2.48 | Δ |
| Sample 34 | Irg184 (5) | | 17.41053459 | Peel NG | | X |
| Sample 35 | Dar1173 (4) | | 11.86394558 | 0.27 | 2.3 | ◯ |
| Sample 36 | Irg184 (7) | | 11.3877551 | 0.28 | 2.4 | ◯ |

Important evaluation indices were selected. The tracking error signal modulation degree (push-pull signal) of L1 was particularly important. This index is defined by the value obtained by dividing the difference signal amplitude (I1−I2)pp by the average level (I1+I2)DC of sum signals shown in FIG. 6. That is, push-pull signal=(I1−I2)pp/(I1+I2)DC. This value must be 0.26 or more. The conducted experiment revealed that since the critical surface tension largely changed in accordance with the ultraviolet-curing resin material, the degrees to which the dye was applied and buried in a groove also largely changed. This largely changed the push-pull signal of L1. When the value was smaller than 0.26, a tracking error of L1 sometimes occurred.

The next important index was the inclination angle (radial tilt) corresponding to the warpage amount of the L0 substrate after the transfer of the ultraviolet-curing resin. The conducted experiment revealed that the cure shrinkage stress of the ultraviolet-curing resin material largely changed, and this largely changed the warpage of the L0 substrate. When the value was 2.6° or more, it was often impossible to decrease the radial tilt of the laminated disks to 0.7° or less, and this adversely affected the tracking characteristics and signal characteristics of the completed double-layer disk. As a consequence, the data error rate often worsened.

When the various tests described above were conducted on the ultraviolet-curing resins, sample 34 was NG because the L1 substrate could not be removed. Also, a tilt was sometimes large although the push-pull signal was 0.26 or more. Sample 29 was the best.

As sample 34 described in Tables 4 and 5 shows, when the oxygen content ratio exceeded 14 atm %, it was often impossible to remove the polycarbonate substrate from the ultraviolet-curing resin layer. Alternatively, the tilt angle increased to 3° or more to cause defective lamination.

Therefore, in one embodiment of the invention, the oxygen content ratio is 11 atm % or more. In some embodiment of the invention, more favorable disks can be obtained by selecting ultraviolet-curing resins by which the oxygen content ratio is 11 to 14 atm %.

A write once information recording medium to be explained in this embodiment has a disk-like transparent resin substrate made of a synthetic resin material such as polycarbonate. This transparent resin substrate has concentric or spiral grooves. The transparent resin substrate can be manufactured by injection molding using a stamper.

A recording film containing an organic dye is formed on the transparent resin substrate so as to fill the grooves.

The organic dye forming the recording film having the L-to-H characteristics has a maximum absorption wavelength region shifted to wavelengths longer than the recording wavelength (405 nm). Also, the organic dye is designed not to extinguish absorption but to have a considerable light absorption in the recording wavelength region.

This decreases the light reflectance when a recording laser beam performs focusing or tracking on tracks before information recording. The laser beam decomposes the dye and decreases the absorbance, so the light reflectance of a recording mark increases. This realizes so-called L-to-H characteristics by which the light reflectance of a recording mark formed by irradiation with a laser beam is higher than a light reflectance before the laser beam irradiation.

The organic dye forming the recording film having the H-to-L characteristics has a maximum absorption wavelength region shifted to wavelengths shorter than the recording wavelength (405 nm). Also, the organic dye is designed to extinguish absorption or have a certain light absorption in the recording wavelength region.

This increases the light reflectance when a recording laser beam performs focusing or tracking on tracks before information recording. The laser beam decomposes the dye and increases the absorbance, so the light reflectance of a recording mark decreases. This realizes so-called H-to-L characteristics by which the light reflectance of a recording mark formed by irradiation with a laser beam is lower than a light reflectance before the laser beam irradiation.

Note that the generated heat sometimes deforms the transparent resin substrate, particularly, the bottom of the groove. This may produce a phase difference in reflected light.

When dissolved in a solvent, the organic dye described above can be easily applied in the form of a liquid to the surface of the transparent resin substrate by spin coating. In this case, the film thickness can be accurately managed by controlling the ratio of dilution by the solvent and the rotational speed of spin coating.

The L-to-H type organic dye can be a dye having a dye portion and counter ion (anion) portion or an organic metal complex. Examples of the dye portion can be a cyanine dye, styryl dye, and porphyrin-based dye. A cyanine dye and styryl dye are particularly suitable because the absorbance to the recording wavelength can be easily controlled.

The H-to-L type organic dye material having a reversed polarity can be especially a quinazoline-based dye in addition to a cyanine-based dye, styryl-based dye, organic metal complex-based dye, porphyrin-based dye, and squarilium-based dye.

In one embodiment of the invention, of the L-to-H type organic dyes, when a monomethine cyanine dye having a monomethine chain is used and the recording film applied on the transparent resin substrate is thinned, the maximum absorption and the absorbance in the recording wavelength region (400 to 405 nm) can be readily adjusted to nearly 0.3 to 0.5. In some embodiment of the invention, the absorbance can be readily adjusted to nearly 0.4. This makes it possible to improve the recording/playback characteristics, and increase the light reflectance and recording sensitivity.

The H-to-L type organic dye material having a reversed polarity can be especially a quinazoline-based dye in addition to a cyanine-based dye, styryl-based dye, organic metal complex-based dye, porphyrin-based dye, and squarilium-based dye.

In one embodiment of the invention, of the H-to-L type organic dyes, when a quinazoline-based dye is used and the recording film applied on the transparent resin substrate is thinned, the maximum absorption and the absorbance in the recording wavelength region (400 to 405 nm) can be readily adjusted to nearly 0.02 to 0.3. In some embodiment of the invention, the absorbance can be readily adjusted to nearly 0.1 to 0.2. This makes it possible to improve the recording/playback characteristics, and increase the light reflectance and recording sensitivity.

The anion portion of the L-to-H type organic dye is preferably an organic metal complex from the viewpoint of the light stability as well. An organic metal complex containing cobalt or nickel as a central metal is particularly superior in light stability.

An azo metal complex is most favorable as the L-to-H type organic dye and has high solubility when 2,2,3,3-tetrafluoro-1-propanol (TFP) is used as a solvent. This facilitates preparation of a solution for spin coating. In addition, since the solution can be recycled after spin coating, the manufacturing cost of the information recording medium can be reduced.

Note that the organic metal complex can be dissolved in a TFP solution and spin-coated. An azo metal complex is particularly favorable as the L0 recording layer made of a thin Ag alloy layer because deformation rarely occurs after recording. Although Cu, Ni, Co, Zn, Fe, Al, Ti, V, Cr, or Y can be used as a central metal, Cu, Ni, and Co are especially preferable in playback light resistance. Cu has no genetic toxicity and improves the quality of a recording/playback signal.

Various materials can be used as ligands surrounding the central metal. Examples are dyes represented by formulas (D1) to (D6) below. It is also possible to form another structure by combining these ligands.

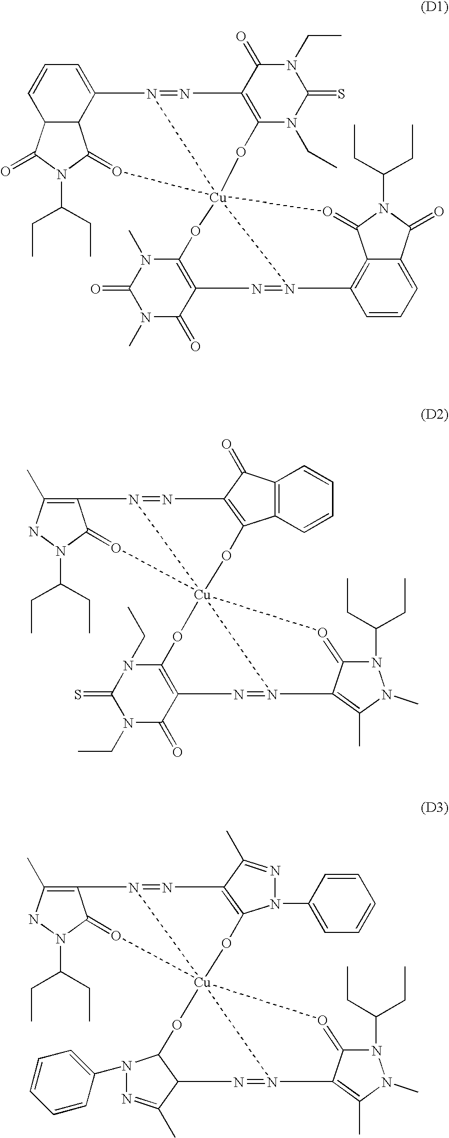

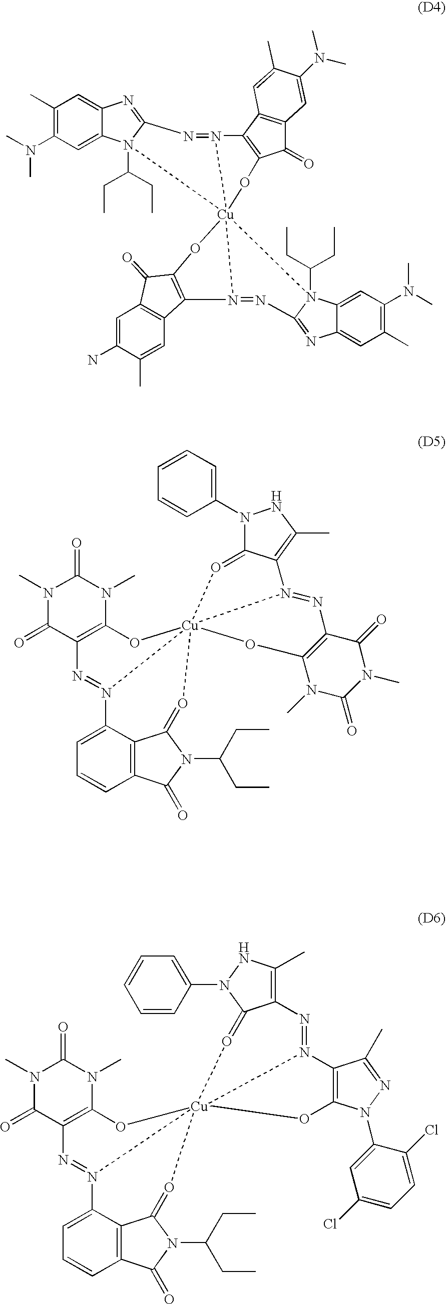

These azo metal complexes can also be used as the L-to-H type organic dye layer. Since the silver film or silver alloy film for L1 is thick, even a dye which easily deforms can be used. It is also possible to use a cationic dye or anionic dye. Recoding films for L1 and L2 must have a high recording sensitivity.

FIG. 6 shows dyes A to D as four examples of an organic dye material usable as the L-to-H type organic dye layer. The dye A has a styryl dye as a dye portion (cation portion) and azo metal complex 1 as an anion portion. The dye C has a styryl dye as a dye portion (cation portion) and azo metal complex 2 as an anion portion. The dye D has a monomethinecyanine dye as a dye portion (cation portion) and azo metal complex 1 as an anion portion. Note that an organic metal complex can also be singly used. As an example, the dye B is a nickel complex dye.

The disk substrate coated with the thin organic dye film by spin coating is heated to a temperature of about 80° C. on a hot plate or in a clean oven, thereby drying the dye. Then, a thin metal film serving as a light reflecting film is formed on the thin organic dye film by sputtering. Examples of this metal reflecting film material are Au, Ag, Cu, Al, and alloys of these metals.

After that, the metal film is spin-coated with an ultraviolet-curing resin, and a protective disk substrate is adhered, thereby manufacturing a write once optical disk as a write once information recording medium.

Formula E1 indicates the formula of the styryl dye as the dye portions of the dyes A and C. Formula E2 indicates the formula of the azo metal complex as the anion portions of the dyes A and C. Formula E3 indicates the formula of the monomethinecyanine dye as the dye portion of the dye D.

Formula E4 indicates the formula of the azo metal complex as the anion portion of the dye D.

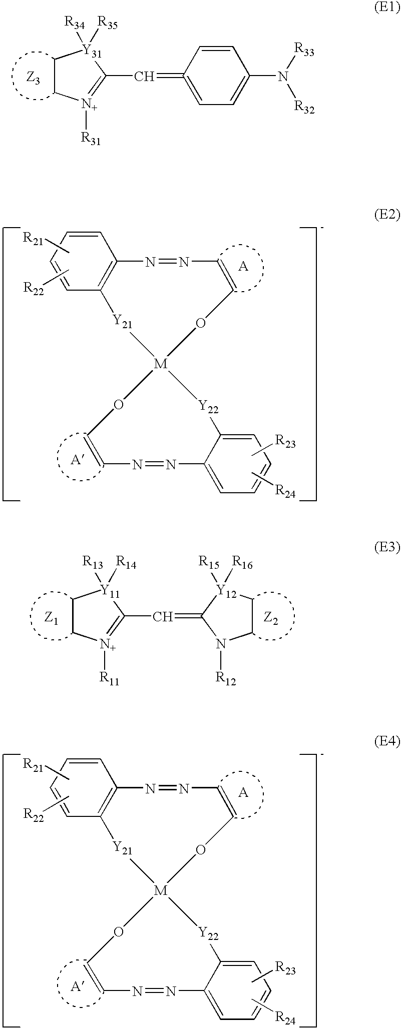

In the formula of the styryl dye, Z₃ represents an aromatic ring, and this aromatic may have a substituent group. Y₃₁ represents a carbon atom or hetero atom. R₃₁, R₃₂, and R₃₃ represent the same aliphatic hydrocarbon group or different aliphatic hydrocarbon groups, and these aliphatic hydrocarbon groups may have a substituent group. R₃₄ and R₃₅ each independently represent a hydrogen atom or appropriate substituent group. When Y₃₁ is a hetero atom, one or both of R₃₄ and R₃₅ do not exist.

In the formula of the monomethinecyanine dye, Z₁ and Z₂ represent the same aromatic ring or different aromatic rings, and these aromatic rings may have a substituent group. Y₁₁ and Y₁₂ each independently represent a carbon atom or hetero atom. R₁₁ and R₁₂ represent aliphatic hydrocarbon groups, and these aliphatic hydrocarbon groups may have a substituent group. R₁₃, R₁₄, R₁₅, and R₁₆ each independently represent a hydrogen atom or appropriate substituent group. When Y₁₁ and Y₁₂ are hetero atoms, some or all of R₁₃, R₁₄, R₁₅, and R₁₆ do not exist.

Examples of the monomethinecyanine dye used in this embodiment are dyes obtained by bonding identical or different cyclic nuclei which may have one or a plurality of substituent groups to the two ends of a monomethine chain which may have one or a plurality of substituent groups. Examples of the cyclic nuclei are an imidazoline ring, imidazole ring, benzoimidazole ring, a-naphthoimidazole ring, β-naphthoimidazole ring, indole ring, isoindole ring, indolenine ring, isoindolenine ring, benzoindolenine ring, pyridinoindolenine ring, oxazoline ring, oxazole ring, isoxazole ring, benzoxazole ring, pyridinoxazole ring, α-naphthoxazole ring, β-naphthoxazole ring, selenazoline ring, selenazole ring, benzoselenazole ring, α-naphthoselenazole ring, β-naphthoselenazole ring, thiazoline ring, thiazole ring, isothiazole ring, benzothiazole ring, α-naphthothiazole ring, β-naphthothiazole ring, tellurazoline ring, tellurazole ring, benzotellurazole ring, α-naphthotellurazole ring, β-naphthotellurazole ring, acridine ring, anthracene ring, isoquinoline ring, isopyrrole ring, imidanoxaline ring, indandione ring, indazole ring, indaline ring, oxadiazole ring, carbazole ring, xanthene ring, quinazoline ring, quinoxaline ring, quinoline ring, chroman ring, cyclohexanedione ring, cyclopentanedione ring, cinnoline ring, thiodiazole ring, thioxazolidone ring, thiophene ring, thionaphthene ring, thiobarbituric acid ring, thiohydantoin ring, tetrazole ring, triazine ring, naphthalene ring, naphthyridine ring, piperazine ring, pyrazine ring, pyrazole ring, pyrazoline ring, pyrazolidine ring, pyrazolone ring, pyran ring, pyridine ring, pyridazine ring, pyrimidine ring, pyrylium ring, pyrrolidine ring, pyrroline ring, pyrrole ring, phenazine ring, phenanthrizine ring, phenanthrene ring, phenanthroline ring, phtharazine ring, puterizine ring, furazane ring, furan ring, purine ring, benzene ring, benzoxazine ring, benzopyran ring, morpholine ring, and rhodanine ring.

In the formulas of the monomethinecyanine dye and styryl dye, Z₁ to Z₃ represent aromatic rings such as a benzene ring, naphthalene ring, pyridine ring, quinoline ring, and quinoxaline ring, and these aromatic rings may have one or a plurality of substituent groups. Examples are aliphatic hydrocarbon groups such as a methyl group, trifluoromethyl group, ethyl group, propyl group, isopropyl group, butyl group, isobutyl group, sec-butyl group, tert-butyl group, pentyl group, isopentyl group, neopentyl group, tert-pentyl group, 1-methylpentyl group, 2-methylpentyl group, hexyl group, isohexyl group, 5-methylhexyl group, heptyl group, and octyl group; alicyclic hydrocarbon groups such as a cyclopropyl group, cyclobutyl group, cyclopentyl group, and cyclohexyl group; aromatic hydrocarbon groups such as a phenyl group, biphenylyl group, o-tolyl group, m-tolyl group, p-tolyl group, xylyl group, mesityl group, o-cumenyl group, m-cumenyl group, and p-cumenyl group; ether groups such as a methoxy group, trifluoromethoxy group, ethoxy group, propoxy group, isopropoxy group, butoxy group, sec-butoxy group, tert-butoxy group, pentyloxy group, phenoxy group, and benzoyloxy group; ester groups such as a methoxycarbonyl group, trifluoromethoxycarbonyl group, ethoxycarbonyl group, propoxycarbonyl group, acetoxy group, and benzoyloxy group; halogen groups such as a fluoro group, chloro group, bromo group, and iodo group; thio groups such as a methylthio group, ethylthio group, propylthio group, butylthio group, and phenylthio group; sulfamoyl groups such as a methylsulfamoyl group, dimethylsulfamoyl group, ethylsulfamoyl group, diethylsulfamoyl group, propylsulfamoyl group, dipropylsulfamoyl group, butylsulfamoyl group, and dibutylsulfamoyl group; amino groups such as a primary amino group, methylamino group, dimethylamino group, ethylamino group, diethylamino group, propylamino group, dipropylamino group, isopropylamino group, diisopropylamino group, butylamino group, dibutylamino group, and piperidino group; carbamoyl groups such as a methylcarbamoyl group, dimethylcarbamoyl group, ethylcarbamoyl group, diethylcarbamoyl group, propylcarbamoyl group, and dipropylcarbamoyl group; and a hydroxy group, carboxy group, cyano group, nitro group, sulfino group, sulfo group, and mesyl group. Note that in these formulas, Z₁ and Z₂ can be the same or different.

In the formulas of the monomethinecyanine dye and styryl dye, Y₁₁, Y₁₂, and Y₃₁ each represent a carbon atom or hetero atom. Examples of the hetero atom are group-XV and group-XVI atoms in the periodic table, such as a nitrogen atom, oxygen atom, sulfur atom, selenium atom, and tellurium atom. Note that the carbon atom represented by Y₁₁, Y₁₂, or Y₃₁ may also be an atomic group mainly containing two carbon atoms, such as an ethylene group or vinylene group. Note also that Y₁₁ and Y₁₂ in the formula of the monomethinecyanine dye can be the same or different.

In the formulas of the monomethinecyanine dye and styryl dye, R₁₁, R₁₂, R₁₃, R₃₂, and R₃₃ each represent an aliphatic hydrocarbon group. Examples of the aliphatic hydrocarbon group are a methyl group, ethyl group, propyl group, isopropyl group, isopropenyl group, 1-propenyl group, 2-propenyl group, butyl group, isobutyl group, sec-butyl group, tert-butyl group, 2-butenyl group, 1,3-butadienyl group, pentyl group, isopentyl group, neopentyl group, tert-pentyl group, 1-methylpentyl group, 2-methylpentyl group, 2-pentenyl group, hexyl group, isohexyl group, 5-methylhexyl group, heptyl group, and octyl group. This aliphatic hydrocarbon group may have one or a plurality of substituent groups similar to those of Z₁ to Z₃.

Note that R₁₁ and R₁₂ in the formula of the monomethinecyanine dye can be the same or different, and R₁₃, R₃₂, and R₃₃ in the formula of the styryl dye can also be the same or different.

R₁₃ to R₁₆, R₃₄, and R₃₅ in the formulas of the monomethinecyanine dye and styryl dye each independently represent a hydrogen atom or appropriate substituent group in the individual formulas. Examples of the substituent group are aliphatic hydrocarbon groups such as a methyl group, trifluoromethyl group, ethyl group, propyl group, isopropyl group, butyl group, isobutyl group, sec-butyl group, tert-butyl group, pentyl group, isopentyl group, neopentyl group, tert-pentyl group, 1-methylpentyl group, 2-methylpentyl group, hexyl group, isohexyl group, 5-methylhexyl group, heptyl group, and octyl group; ether groups such as methoxy group, trifluoromethoxy group, ethoxy group, propoxy group, butoxy group, tert-butoxy group, pentyloxy group, phenoxy group, and benzoyloxy group; halogen groups such as a fluoro group, chloro group, bromo group, and iodo group; and a hydroxy group, carboxy group, cyano group, and nitro group. Note that when Y₁₁, Y₁₂, and Y₃₁ are hetero atoms in the formulas of the monomethinecyanine dye and styryl dye, some or all of R₁₃ to R₁₆ in Z₁ and Z₂ and one or both of R₃₄ and R₃₅ in Z₃ do not exist.

In the formula of the azo metal complex, A and A′ represent 5- to 10-membered heterocyclic groups which are the same or different and each contain one or a plurality of hetero atoms selected from a nitrogen atom, oxygen atom, sulfur atom, selenium atom, and tellurium atom. Examples of the heterocyclic groups are a furyl group, thienyl group, pyrrolyl group, pyridyl group, piperidino group, piperidyl group, quinolyl group, and isoxazolyl group. This heterocyclic group may have one or a plurality of substituent groups. Examples are aliphatic hydrocarbon groups such as a methyl group, trifluoromethyl group, ethyl group, propyl group, isopropyl group, butyl group, isobutyl group, sec-butyl group, tert-butyl group, pentyl group, isopentyl group, neopentyl group, tert-pentyl group, 1-methylpentyl group, 2-methylpentyl group, hexyl group, isohexyl group, and 5-methylhexyl group; ester groups such as a methoxycarbonyl group, trifluoromethoxycarbonyl group, ethoxycarbonyl group, propoxycarbonyl group, acetoxy group, trifluoroacetoxy group, and benzoyloxy group; aromatic hydrocarbon groups such as a phenyl group, biphenylyl group, o-tolyl group, m-tolyl group, p-tolyl group, o-cumenyl group, m-cumenyl group, p-cumenyl group, xylyl group, mesityl group, styryl group, cinnamoyl group, and naphthyl group; and a carboxy group, hydroxy group, cyano group, and nitro group.

Note that an azo compound forming the azo-based organic metal complex represented by the formula can be obtained in accordance with the conventional method by reacting a diazonium salt having R₂₁ and R₂₂ or R₂₃ and R₂₄ corresponding to the formula with a heterocyclic compound having an active methylene group adjacent to a carbonyl group in the molecule. Examples of the heterocyclic compound are an isoxazolone compound, oxazolone compound, thionaphthene compound, pyrazolone compound, barbituric acid compound, hydantoin compound, and rhodanine compound. Y₂₁ and Y₂₂ represent hetero atoms which are the same or different and selected from group-XVI elements in the periodic table, e.g., an oxygen atom, sulfur atom, selenium atom, and tellurium atom.

The azo metal complex represented by the formula is normally used in the form of a metal complex in which one or a plurality of azo metal complexes are coordinated around a metal (central atom). Examples of a metal element serving as the central atom are scandium, yttrium, titanium, zirconium, hafnium, vanadium, niobium, tantalum, chromium, molybdenum, tungsten, manganese, technetium, rhenium, iron, ruthenium, osmium, rhodium, iridium, nickel, palladium, platinum, copper, silver, gold, zinc, cadmium, and mercury. Particularly preferably, cobalt is frequently used among other metals.

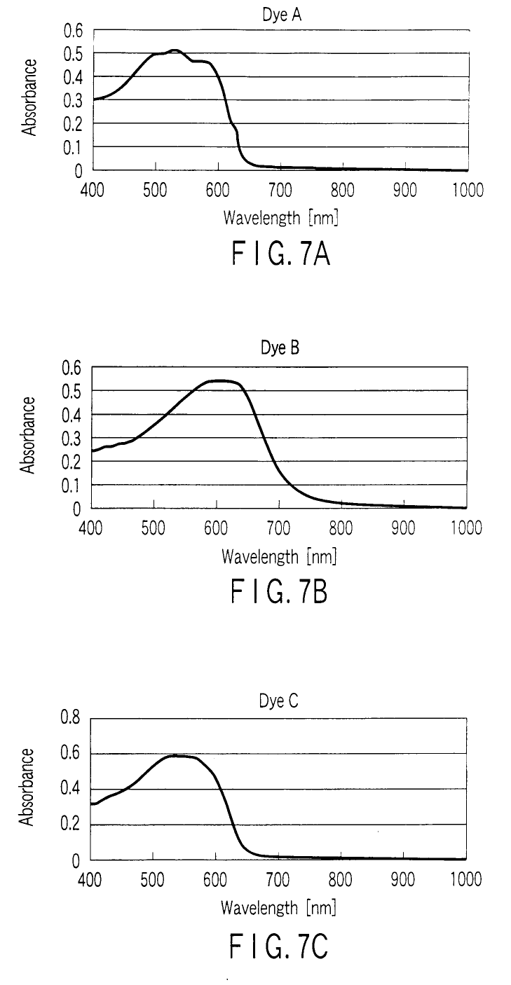

FIG. 7A shows the change in absorbance of the dye A with respect to the wavelength of an emitted laser beam. FIG. 7B shows the change in absorbance of the dye B with respect to the wavelength of an emitted laser beam. FIG. 7C shows the change in absorbance of the dye C with respect to the wavelength of an emitted laser beam.

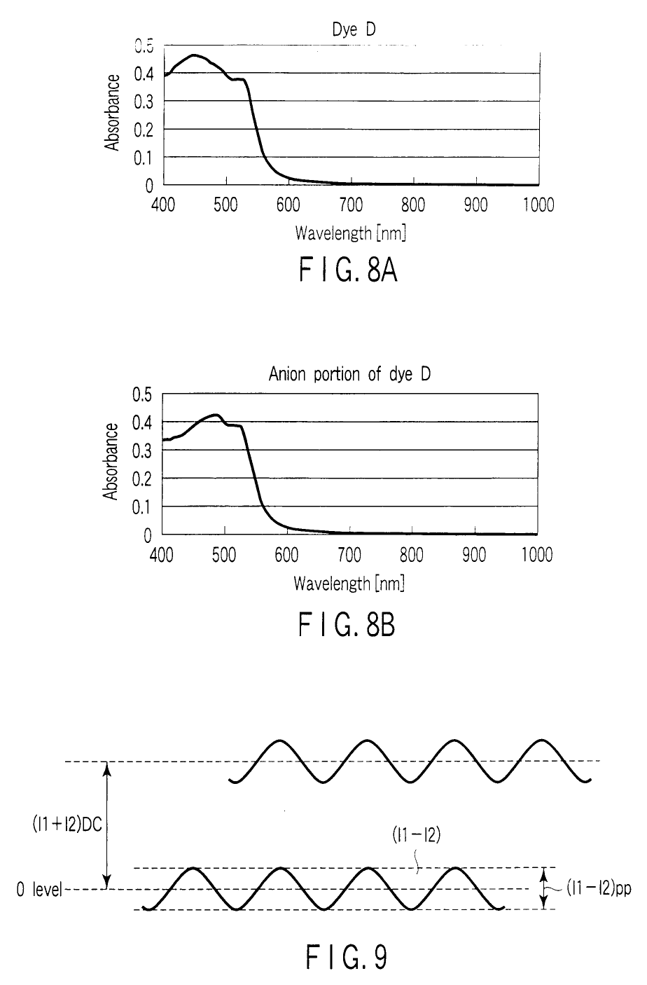

FIG. 8A shows the change in absorbance of the dye D with respect to the wavelength of an emitted laser beam. FIG. 8B shows the change in absorbance of the anion portion of the dye D with respect to the wavelength of an emitted laser beam.

As is evident from the characteristics shown in FIGS. 7A to 8B, the dyes A to D have maximum absorption wavelength regions shifted to wavelengths longer than the recording wavelength (405 nm). The write once optical disk explained in this embodiment comprises the recording film containing the organic dye having the characteristics as described above, and has the so-called L-to-H characteristics by which the light reflectance after laser beam irradiation is higher than that before the laser beam irradiation. Even when a short-wavelength laser beam such as a blue laser is used, therefore, this write once optical disk is superior in, e.g., storage durability, playback signal S/N ratio, and bit error rate, and capable of recording and playing back information at a high density with performance on a well practical level.

That is, in this write once optical disk, the maximum absorption wavelength of the recording film containing the organic dye is longer than the wavelength of the recording laser beam. Since this reduces the absorption of short-wavelength light such as ultraviolet radiation, the optical stability and the reliability of information recording/playback increase.

Also, since the light reflectance is low when information is recorded, no cross write occurs owing to reflective diffusion. Therefore, even when information is recorded on an adjacent track, it is possible to reduce the deterioration of the playback signal S/N ratio and bit error rate. Furthermore, the contrast and resolution of a recording mark can be kept high even against heat. This facilitates recording sensitivity design.

The dyes A to D have maximum absorption wavelength regions shifted to wavelengths shorter than the recording wavelength (405 nm). The write once optical disk explained in this embodiment comprises the recording film containing the organic dye having the characteristics as described above, and has the so-called H-to-L characteristics by which the light reflectance after laser beam irradiation is lower than that before the laser beam irradiation. Even when a short-wavelength laser beam such as a blue laser is used, therefore, this write once optical disk has a high reflectance, is superior in, e.g., playback signal S/N ratio and bit error rate, and can record and play back information at a high density with performance on a well practical level.

That is, in this write once optical disk, the maximum absorption wavelength of the recording film containing the organic dye is shorter than the wavelength of the recording laser beam. Since this can absorb or reflect to a certain degree short-wavelength light such as ultraviolet radiation, the optical stability and the reliability of information recording/playback increase.

Furthermore, the contrast and resolution of a recording mark can be kept high even against heat. This facilitates recording sensitivity design.

The shape of a groove as a recording/playback track of the write once optical disk has a large effect on the recording/playback characteristics. The present inventors made extensive studies, and have found that the relationship between the groove width and land width is particularly important.

That is, if the groove width is equal to or smaller than the land width, the playback signal S/N ratio and bit error rate of recorded information often deteriorate. In other words, when the groove width is larger than the land width, good recording/playback characteristics can be obtained.

Also, to record information on a writable optical disk, various pieces of address information such as a track number, sector number, segment number, and ECC (Error Checking and Correcting) block address number must be prerecorded on the optical disk.

A means for recording these pieces of address information can be implemented by wobbling (zigzagging) the groove in the radial direction of the optical disk. That is, the address information can be recorded by wobble by using, e.g., a means for modulating the wobble frequency in accordance with the address information, a means for modulating the wobble amplitude in accordance with the address information, a means for modulating the wobble phase in accordance with the address information, or a means for modulating the wobble polarity reversing interval in accordance with the address information. It is also possible to use a means which uses not only the wobble groove but also the change in land height, i.e., a means for burying a prepit in the land.

The address information can be played back by reading a push-pull signal after tracking. The quality of the read wobble signal itself is evaluated by a normalized wobble amplitude NWS and wobble CNR (Carrier-to-Noise Ratio) (=wobble NBSNR: Narrow Band Signal-to-Noise Ratio).

As shown in FIG. 9, the normalized wobble amplitude NWS is a value Wppmin/(I1−I2)pp obtained by dividing the amplitude of a push-pull signal played back when a groove is tracked, i.e., a minimum groove wobble signal amplitude (an amplitude when the wobble phase is opposite to that of an adjacent groove) Wpmin by a push-pull signal amplitude (I1−I2)pp when a light spot traverses an unrecorded groove.

In one embodiment of the invention, the NWS is 0.10 or more. In some embodiment of the invention, the NWS is 0.10 to 0.45. In some embodiment of the invention, the NWS is 0.10 to 0.25. In one embodiment of the invention, the wobble NBSNR is 18 dB or more. In some embodiment of the invention, the wobble NBSNR is 26 dB or more.

Note that the wobble signal itself has an influence on the bit error rate of recorded information, so the amplitude of the signal must be held within a certain range. Since this wobble amplitude range changes in accordance with an organic dye material used, it is necessary to set an optimum range capable of achieving good L-to-H characteristics.

Note also that not only the wobble amplitude but also the groove depth has a large influence on the recording/playback characteristics.

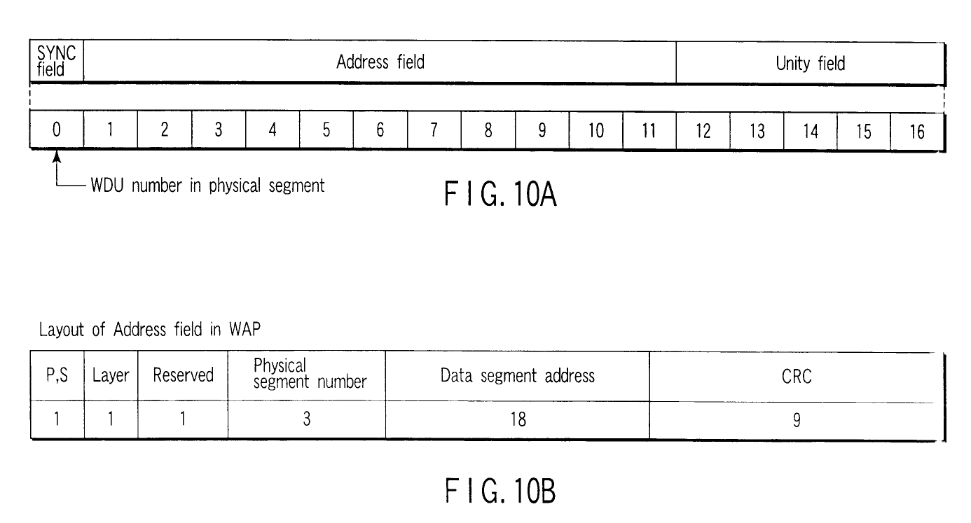

Wobble address data configurations as shown in FIGS. 10A and 10B are convenient for a Low-to-High polarity disk. The wobble frequency is about 696.7742 kHz when the playback linear velocity is 6.61 m/sec. When the channel bit rate of recorded data is 64.80 Mbps, a 93-channel bit length is one period of wobble.

As shown in FIG. 10A, a synchronization field (SYNC field), address field, and unity field form one physical segment (sector) of address data, and the address data has a total of 17 wobble data units WDU.

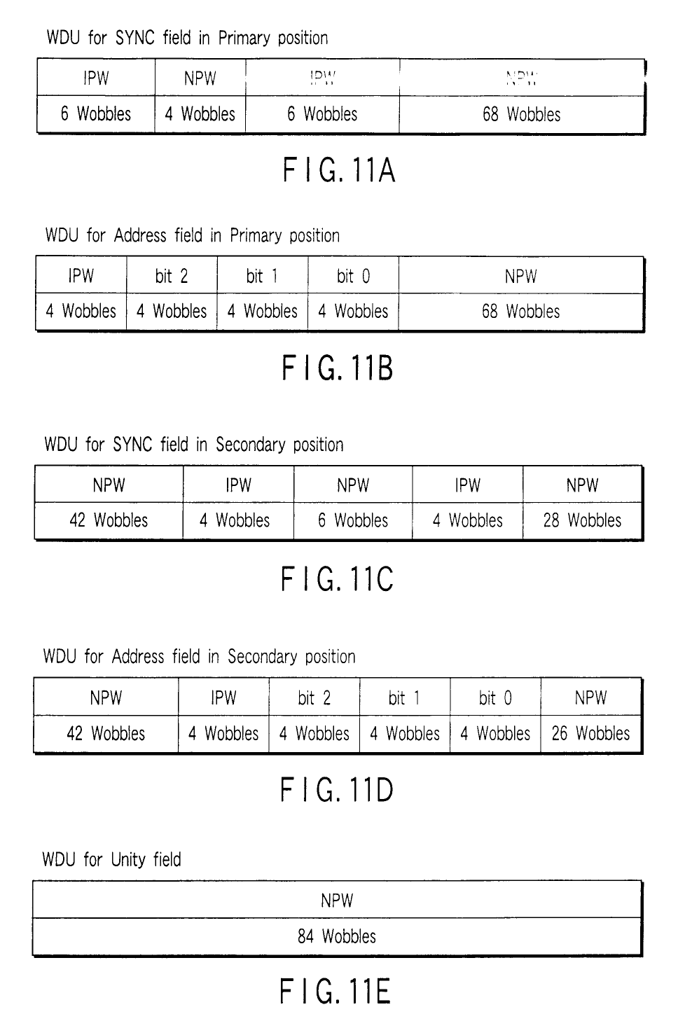

As shown in FIG. 10B, the address field contains identification code information (P,S), layer information, physical segment number, data segment address, and CRC. The wobble data unit WDU is made up of 84 wobble waves, and there are five types of WDUs as shown in FIGS. 11A to 11E. The SYNC field and address field each have two types of WDUs, i.e., they have a total of four WDUs, and the unity field has one WDU.

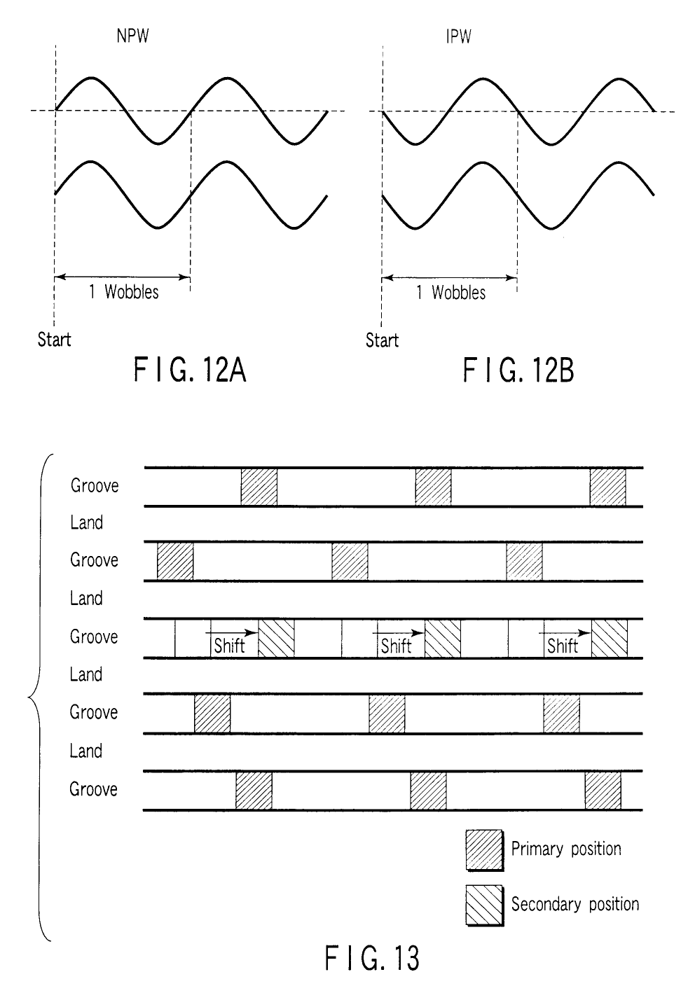

3-bit data is embedded by wobble in the WDU of the address field. As shown in FIGS. 12A and 12B, data 0 and data 1 respectively correspond to an NPW (Normal Phase Wobble) and IPW (Inverted Phase Wobble).

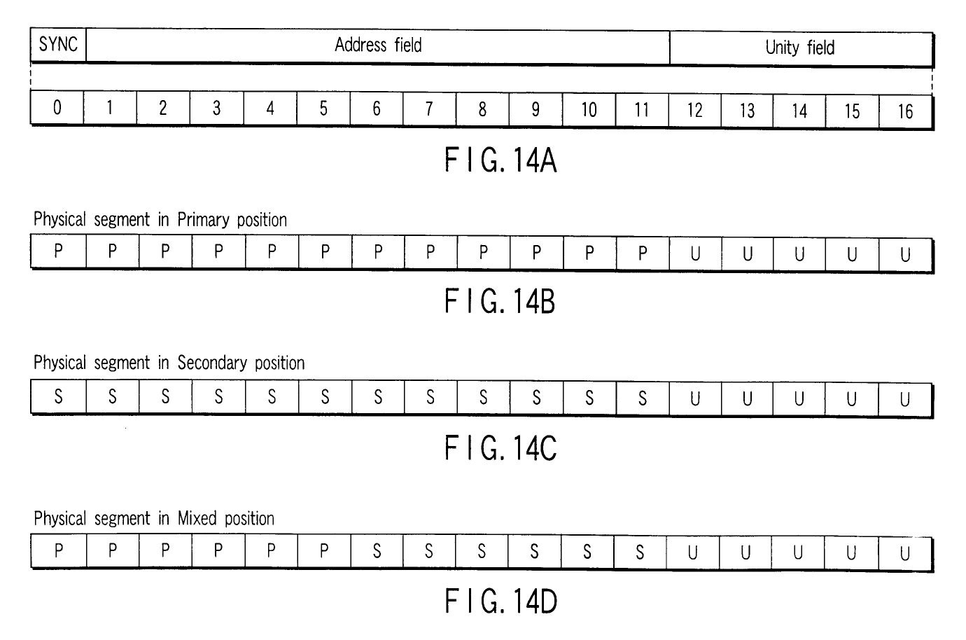

As shown in FIG. 13, the wobble data bit portions are shifted so that they do not appear in the same phase positions of adjacent grooves. For this purpose, the address field has two types of WDUs, i.e., a primary position and secondary position, and the SYNC field also has two types of WDUs accordingly. Consequently, the physical segment has a total of three types of configurations as shown in FIGS. 14B to 14D.

The address data format as described above is particularly effective in a write once optical disk having a Low-to-High type recording film. This is so because a low reflectance of the original unrecorded state prevents easy occurrence of interference of wobble phase information between adjacent grooves. Although a certain error rate can be obtained without switching the primary and secondary positions, the switching further improves the error rate.

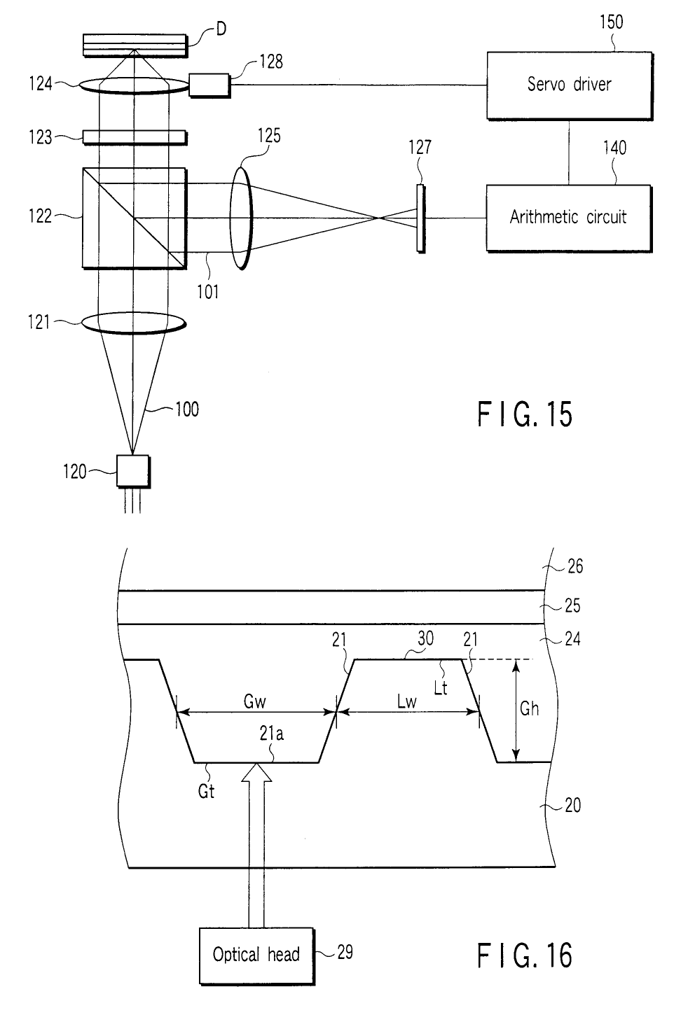

FIG. 15 is a block diagram showing an outline of the arrangement of a disk apparatus for playing back the write once information recording medium described above.

As shown in FIG. 15, a write once information recording medium D is, e.g., the single-sided, triple-layer write once information recording medium shown in FIG. 3. A short-wavelength semiconductor laser source 120 is used as the light source. The wavelength of the emitted beam has a violet wavelength band of, e.g., 400 to 410 nm. An emitted beam 100 from the semiconductor laser source 120 is collimated into a parallel beam by a collimating lens 121, and enters an objective lens 124 through a polarizing beam splitter 122 and λ/4 plate 123. After that, the emitted beam 100 concentrates to each information recording layer through the substrate of the write once information recording medium D. Reflected light 101 from the information recording layer of the write once information recording medium D is transmitted through the substrate of the write once information recording medium D again, and reflected by the polarizing beam splitter 122 through the objective lens 124 and λ/4 plate 123. After that, the reflected light 101 enters a photodetector 127 through a condenser lens 125.

A light-receiving part of the photodetector 127 is normally divided into a plurality of portions, and each light-receiving portion outputs an electric current corresponding to the light intensity. A 1/V amplifier (current-to-voltage converter) (not shown) converts the output electric current into a voltage, and applies the voltage to an arithmetic circuit 140. The arithmetic circuit 140 calculates, e.g., a tilt error signal, HF signal, focusing error signal, and tracking error signal from the input voltage signal. The tilt error signal is used to perform tilt control, the HF signal is used to play back information recorded on the write once information recording medium D, the focusing error signal is used to perform focusing control, and the tracking error signal is used to perform tracking control.

An actuator 128 can drive the objective lens 124 in the vertical direction, disk radial direction, and tilt direction (the radial direction and/or tangential direction). A servo driver 150 controls the actuator 128 so that the objective lens 124 follows an information track on the write once information recording medium D. Note that there are two types of tilt directions: “a radial tilt” which occurs when the disk surface inclines toward the center of the write once optical disk; and “a tangential tilt” which occurs in the tangential direction of a track. A tilt which generally occurs owing to the warpage of a disk is the radial tilt. It is necessary to take account of not only a tilt which occurs during the manufacture of a disk but also a tilt which occurs owing to a change with time or a rapid change in use environment.

As shown in FIG. 16, a recording/playback laser beam emitted from an optical head 29 enters an HD DVD-R disk serving as a write once information recording medium formed as described above, from the surface opposite to the surface coated with a recording film 24 of a disk substrate 20.

A bottom surface 21a of a groove 21 formed in the disk substrate 20 and a land 30 sandwiched between adjacent grooves 21 are information recording tracks. A recording track formed by the bottom surface 21a of the groove 21 will be referred to as a groove track Gt thereinafter. A recording track formed by the land 30 will be referred to as a land track Lt hereinafter.

Also, the difference of the surface height of the groove track Gt from that of the land track Lt will be referred to as the groove depth Gh hereinafter. Furthermore, the width of the groove track Gt at a substantially ½ height of the groove depth Gh will be referred to as a groove width Gw, and the width of the land track Lt at a substantially ½ height of the groove depth Gh will be referred to as a land width Lw hereinafter.

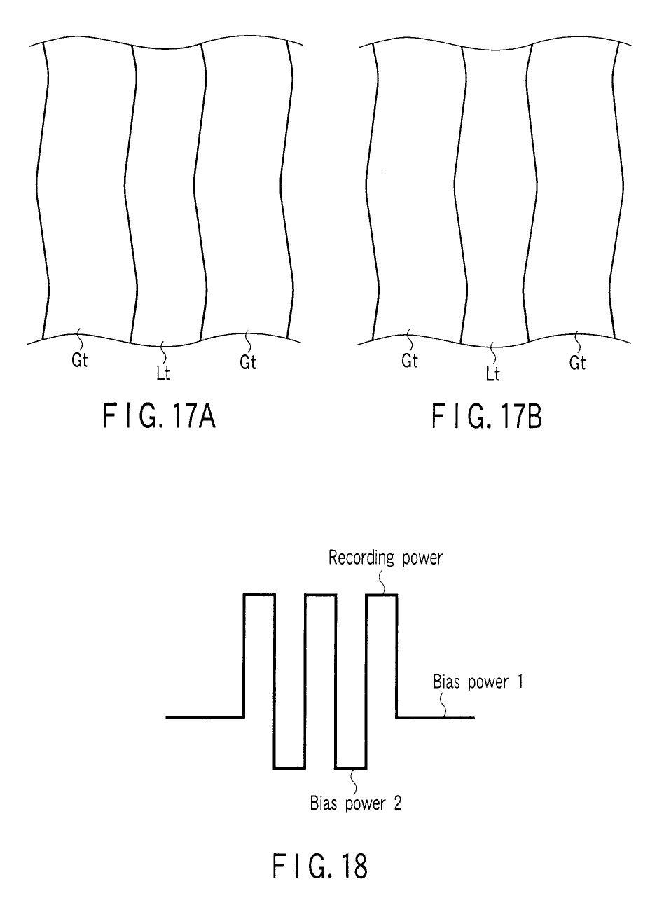

As described previously, the groove track Gt is wobbled to record various pieces of address information. FIG. 17A shows a case in which adjacent groove tracks Gt have the same phase. FIG. 17B shows a case in which adjacent groove tracks Gt have opposite phases. Adjacent groove tracks Gt have various phase differences depending on the region of the write once information recording medium 28.

### EXAMPLES

The present invention will be described in more detail below by way of its examples.

A double-layer HD DVD-R disk was manufactured as a sample of the write once information recording medium according to the present invention.

(Preparation of L0 Stamper)

Glass disks 200 mm in diameter and 6 mm in thickness precisely polished to have a surface roughness Ra of 0.3 nm were cleaned in the order of inorganic alkali solution cleaning, ultrapure water cleaning, electrolytic degreasing, hot water cleaning, and pull-up drying by using a cleaning apparatus manufactured by TECHNO OKABAYASHI.

Then, the surface of the glass disk was spin-coated with HMDS (hexamethyldisilazane) by using a resist coating apparatus (manufactured by Access), and further spin-coated with a photoresist (DVR300 manufactured by ZEON). After that, the glass disk was prebaked on a hot plate (100° C., 10 min).

An HD DVD-R L0 signal corresponding to a concentric or spiral pattern was recorded on the resist-coated glass disks by using a UV laser cutting machine (LBR manufactured by Matsushita Electric). The UV laser was a krypton ion laser having a wavelength of 351 nm, and the objective lens was an NA-0.90 type lens manufactured by Corning Toropel. The HD DVD-R signal source used was an HD DVD-R formatter manufactured by KENWOOD TMI.

Then, the recorded resist disks were spin-developed by a developing apparatus (manufactured by Access). The developer used was a dilute inorganic alkali developer prepared by mixing ultrapure water in an inorganic alkali developer (DE3 manufactured by TOKYO OHKA KOGYO) at a mixing ratio of 2:1.

Subsequently, an Ni sputtering apparatus (manufactured by Victor Company of Japan) was used to sputter a thin Ni film on each developed disk to make it conductive. The Ni film thickness was 10 nm. After that, Ni electroforming was performed in a nickel sulfamate solution hot bath by using an electroforming apparatus (manufactured by NOVEL), thereby removing the Ni film from the resist disk. The duplicated Ni stamper was then spin-cleaned and ashed with oxygen by an RIE apparatus to remove the residual photoresist from the surface. After that, the Ni stamper surface was spin-coated with a protective film (CLEANCOAT S manufactured by FINE CHEMICAL JAPAN), and an L0 stamper was completed by polishing the back surface, and punching the inner and outer diameters.

(Preparation of Mother Stamper for L1 and L2)

Glass disks 200 mm in diameter and 6 mm in thickness precisely polished to have a surface roughness Ra of 0.3 nm were prepared and cleaned in the order of inorganic alkali solution cleaning, ultrapure water cleaning, electrolytic degreasing, hot water cleaning, and pull-up drying by using the cleaning apparatus manufactured by TECHNO OKABAYASHI.

Then, the surface of each glass disk was spin-coated with HMDS (hexamethyldisilazane) by using the resist coating apparatus (manufactured by Access), and further spin-coated with the photoresist (DVR300 manufactured by ZEON). After that, the glass disk was prebaked on the hot plate (100° C., 10 min).

An HD DVD-R L1 signal corresponding to a concentric or spiral pattern was recorded on these resist-coated glass disks by using the UV laser cutting machine (LBR manufactured by Matsushita Electric). The UV laser was a krypton ion laser having a wavelength of 351 nm, and the objective lens was the NA-0.90 type lens manufactured by Corning Toropel. The HD DVD-R signal source used was the HD DVD-R formatter manufactured by KENWOOD TMI.

Then, the recorded resist disks were spin-developed by the developing apparatus (manufactured by Access). The developer used was the dilute inorganic alkali developer prepared by mixing ultrapure water in the inorganic alkali developer (DE3 manufactured by TOKYO OHKA KOGYO) at a mixing ratio of 2:1.

Subsequently, the Ni sputtering apparatus (manufactured by Victor Company of Japan) was used to sputter a thin Ni film on each developed disk to make it conductive. The Ni film thickness was 10 nm. After that, Ni electroforming was performed in the nickel sulfamate solution hot bath by using the electroforming apparatus (manufactured by NOVEL), thereby removing the Ni film from the resist disk. The duplicated Ni father stamper was spin-cleaned and ashed with oxygen by an RIE apparatus to remove the residual photoresist from the surface. This RIE step was also a passivation process. After that, the electroforming apparatus was used again to electroform the Ni father stamper in the nickel sulfamate bath to duplicate an Ni mother stamper. The surface of this Ni mother stamper was spin-coated with the protective film (CLEANCOAT S manufactured by FINE CHEMICAL JAPAN), and a mother stamper for L1 and L2 was obtained by polishing the back surface, and punching the inner and outer diameters.

(Duplication of Double-Layer HD DVD-R Disk)

A disk was manufactured using a double-layer HD DVD-R mass-production manufacturing line facility manufactured by Origin Electric. The process procedure was as follows.

The L0 stamper was attached to the SD40E injection compression molding apparatus manufactured by Sumitomo Heavy Industries, thereby molding a polycarbonate disk substrate. The polycarbonate resin was AD5503 manufactured by TEIJIN CHEMICALS. The mold was the G mold manufactured by SEIKOH GIKEN. The mold shrinkage factor was 0.6%. The molded plate thickness was 590 μm.

The L1 mother stamper was attached to another injection compression molding apparatus (SD40E manufactured by Sumitomo Heavy Industries), thereby molding a polycarbonate disk substrate. The polycarbonate resin was AD5503 manufactured by TEIJIN CHEMICALS. The mold was the G mold manufactured by SEIKOH GIKEN. The mold shrinkage factor was 0.6%. The molded plate thickness was 590 μm.

In addition, the L2 mother stamper was attached to another injection compression molding apparatus (SD40E manufactured by Sumitomo Heavy Industries), thereby molding a polycarbonate disk substrate. The polycarbonate resin was AD5503 manufactured by TEIJIN CHEMICALS. The mold was the G mold manufactured by SEIKOH GIKEN. The mold shrinkage factor was 0.6%. The molded plate thickness was 590 μm.

After the L0 molded disk substrate was cooled, an L0 organic dye solution was applied by spin coating and dried, and an AgBi (Bi: 0.3% to 1%) film was DC-sputtered (the sputtering apparatus was an HD DVD-R double-layer Ag alloy film formation apparatus manufactured by Unaxis) to form the L0 recording layer. The thickness of the AgBi film was 10 nm. After that, an ultraviolet-curing resin was applied by spin coating, adhered to the Li molded disk substrate, and cured by ultraviolet radiation. The thickness of the ultraviolet-curing resin layer was 14 μm. When the Li molded disk substrate was removed after that, a transfer pattern of the Li molded substrate was transferred to the surface of the ultraviolet-curing resin on the L0 substrate. This pattern was an Li pattern. After that, an Li organic dye solution was applied by spin coating and dried, and an AgBi (Bi: 0.3% to 1%) film was DC-sputtered to form the L1 recording layer including the L1 organic dye layer and reflecting layer. The sputtering apparatus was an HD DVD-R double-layer Ag alloy film formation apparatus manufactured by Unaxis. The thickness of the AgBi film was 15 nm. After that, an ultraviolet-curing resin was applied by spin coating, adhered to the L2 molded disk substrate, and cured by ultraviolet radiation. The thickness of the ultraviolet-curing resin layer was 14 μm. When the L2 molded disk substrate was removed after that, a transfer pattern of the L2 molded substrate was transferred to the surfaces of the ultraviolet-curing resin on a composite substrate of the L0 and L1 substrates. This pattern was an L2 pattern. Then, an L2 organic dye solution was applied by spin coating and dried. Spattering is performed as in the L1 recording layer except that the thickness of an AgBi (Bi: 0.3% to 1%) film is 100 nm. Then, a UV adhesive (6810 manufactured by DAINIPPON INK AND CHEMICALS) was applied by spin coating, adhered to the L1 molded substrate already used and removed, and cured by ultraviolet radiation. After that, a label was printed by a label printer.

Thus, a triple-layer HD DVD-R disk was manufactured.

Note that in order to manufacture a double-layer HD DVD-R disk, an L1 recording layer is formed. Then, a UV adhesive can be applied by spin coating, adhere to the L1 molded substrate already used, and cure by ultraviolet radiation.

The L-to-H type organic dye was prepared by mixing the dyes D5 and D6 at a ratio of 9:1, or the dyes D2 and D3 at a ratio of 1:1. The H-to-L type organic dye was a quinazoline-based dye represented by formula (F1).

Note that the quinazoline-based dye is represented by formula (F2) below. In the present invention, it is possible to preferably use quinazoline-based dyes represented by formulas (F3) to (F7) below, in addition to the quinazoline-based dye represented by formula (F1) above.

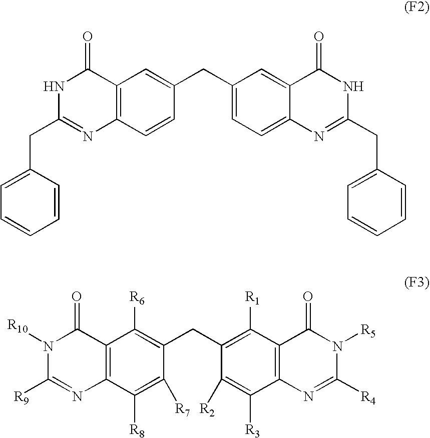

wherein R₁ to R₁₀ each independently represent a hydrogen atom, a halogen atom, a nitro group, a cyano group, a hydroxyl group, a carboxyl group, a substituted or nonsubstituted alkyl group, a substituted or nonsubstituted aralkyl group, a substituted or nonsubstituted aryl group, a substituted or nonsubstituted metalocenyl group, a substituted or nonsubstituted alkoxy group, a substituted or nonsubstituted aralkyloxy group, a substituted or nonsubstituted aryloxy group, a substituted or nonsubstituted alkylthio group, a substituted or nonsubstituted aralkylthio group, a substituted or nonsubstituted arylthio group, a substituted or nonsubstituted acyl group, a substituted or nonsubstituted acyloxy group, a substituted or nonsubstituted alkoxycarbonyl group, a substituted or nonsubstituted aralkyloxycarbonyl group, a substituted or nonsubstituted aryloxycarbonyl group, a substituted or nonsubstituted amino group, or a group having a metalocenyl residue.

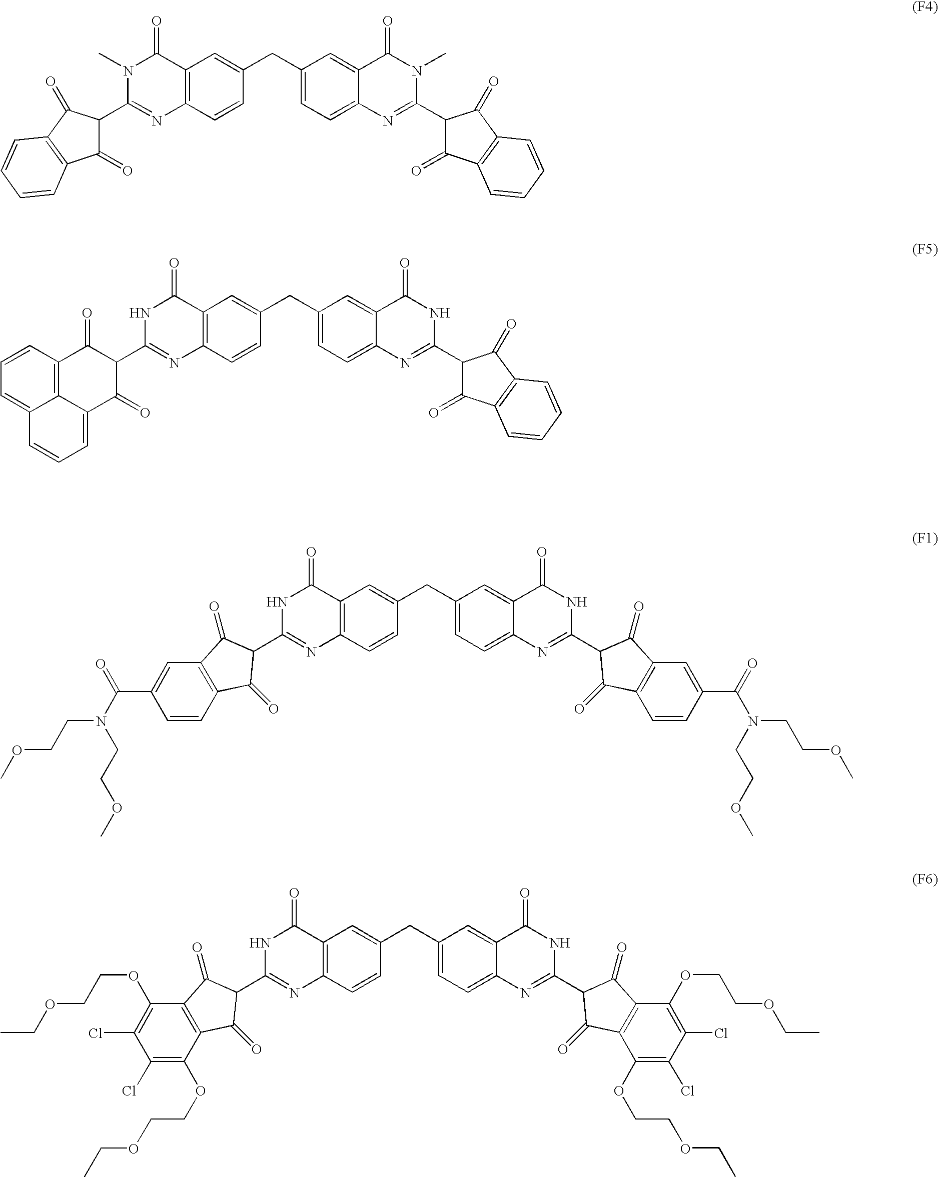

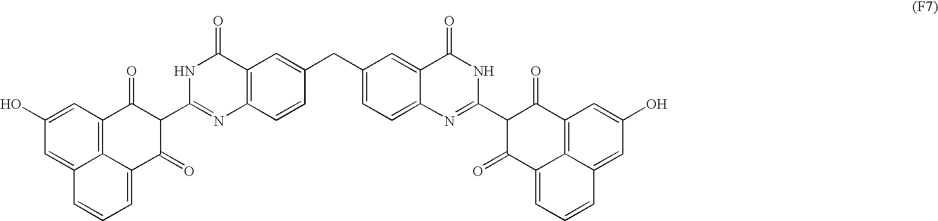

Triple-layer HD DVD-R disks were manufactured by using different combinations of the L-H organic dye and H-L organic dye in the first, second, and third organic dye layers, and using an ultraviolet-curing resin, and the reflectance and playback durability count of each disk were measured.

As an organic dye solution for forming an organic dye layer by coating, it is possible to use a solution prepared by dissolving 1.2 g (wt %) of an organic dye powder in 100 mL of TFP and having a solution concentration of 1.2%. The dye powder was put in the solvent and dissolved by applying ultrasonic waves for 30 min.

The reflectance was measured using ODU1000 manufactured by Pulstec.

The playback durability count was evaluated by repetitively performing recording and playback on the groove track Gt of each obtained write once information recording medium, conducting an evaluation test, and counting the number of times by which predetermined evaluation characteristics were obtained.

The ODU1000 information recording medium evaluation apparatus manufactured by Pulstec can be used as the evaluation apparatus.

The testing conditions were that the objective lens numerical aperture NA of the optical head 29 was 0.65, the wavelength of the recording/playback laser beam was 405 nm , and the recording/playback linear velocity was 6.61 m/sec. A recording signal was random data having undergone 8-12 modulation, and had a waveform to be recorded by a constant recording power and two types of bias powers 1 and 2 as shown in FIG. 18.

The track pitch was 400 nm, the groove width Gw was “1.1” with respect to “1” as the land width Lw, the wobble amplitude of the groove track Gt was 14 nm, and the groove depth Gh was 90 nm. Note that wobble recording of address information was done by using wobble phase modulation.

As the evaluation characteristics, a carrier-to-noise ratio CNR, partial response signal-to-noise ratio PRSNR, and simulated bit error rate SbER of a playback signal were measured. In one embodiment of the invention, the PRSNR was 15 or more. In some embodiment of the invention, the SbER was 5.0×10⁻⁵ or less.

The PRSNR and SbER can be measured with information being kept recorded on adjacent tracks.

The obtained results were as follows.

### Example 1

| | | |
|---|---|---|
| L0: L to H | 4.1 | 1,100,000 times |
| L1: H to L | 5.2 | 1,020,000 times |
| L2: L to H | 4.0 | 1,500,000 times |

### Example 2

| | | |
|---|---|---|
| L0: L to H | 4.2 | 1,050,000 times |
| L1: L to H | 4.2 | 1,400,000 times |
| L2: H to L | 5.2 | 1,050,000 times |

### Example 3

| | | |
|---|---|---|
| L0: L to H | 4.8 | 1,100,000 times |
| L1: H to L | 4.9 | 1,010,000 times |
| L2: H to L | 5.1 | 1,040,000 times |

### Example 4

| | | |
|---|---|---|
| L0: L to H | 5.8 | 1,600,000 times |
| L1: H to L | 7.0 | 1,050,000 times |

### Comparative Example 1

| | | |
|---|---|---|
| L0: H to L | 5.3 | 50,000 times |
| L1: L to H | 4.0 | 1,030,000 times |
| L2: L to H | 4.2 | 1,080,000 times |

### Comparative Example 2

| | | |
|---|---|---|
| L0: H to L | 6.2 | 40,000 times |
| L1: H to L | 6.3 | 300,000 times |
| L2: H to L | 5.9 | 900,000 times |

### Comparative Example 3

| | | |
|---|---|---|
| L0: H to L | 6.1 | 30,000 times |
| L1: H to L | 5.2 | 300,000 times |
| L2: L to H | 4.1 | 1,200,000 times |

As shown above, only Examples 1, 2, 3, and 4 were satisfactory in reflectance and playback durability count.

That is, the playback beam durability worsened in each example using the H-L dye in the first layer directly irradiated with the laser beam. However, when the L-H dye was used in the first layer, the playback beam durability was 1,000,000 times or more even if the H-L dye was used in the second layer and/or third layer.

Note that the present invention is not directly limited to the embodiments described above, and can be practiced by variously changing the constituent elements without departing from the spirit and scope of the invention. Also, various inventions can be formed by appropriately combining a plurality of constituent elements disclosed in the embodiments. For example, some of all the constituent elements disclosed in the embodiments can be omitted. Furthermore, the constituent elements of different embodiments can be appropriately combined.

Note also that the present invention can provide not only a multilayered write once optical disk having two or three layers, but also a multilayered write once optical disk having four or five layers.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A write once information recording medium comprising:
a transparent resin substrate having a groove and land with one of a concentric shape and a spiral shape;
a first recording film formed on the groove and land of the transparent resin substrate;
an interlayer formed on the first recording film and made of a transparent resin material having a groove and land with said one of the concentric shape and the spiral shape; and
a second recording film formed on the groove and land of the interlayer,
wherein a recording mark is formed in the first recording film and the second recording film by irradiation with a short-wavelength laser beam,
a light reflectance of the recording mark formed in the first recording film by irradiation with the short-wavelength laser beam is higher than a light reflectance before irradiation with the short-wavelength laser beam,
a light reflectance of the recording mark formed in the second recording film by irradiation with the short-wavelength laser beam is lower than a light reflectance before irradiation with the short-wavelength laser beam, and
the groove wobbles within a predetermined amplitude range.

2. A medium according to claim 1, which further comprises:
a second interlayer formed on the second recording film and made of a transparent resin material having a groove and land with said one of the concentric shape and the spiral shape; and
a third recording film formed on the groove and land of the second interlayer, and
in which a light reflectance of the recording mark formed in the third recording film by irradiation with the short-wavelength laser beam is higher than a light reflectance before irradiation with the short-wavelength laser beam.

3. A medium according to claim 1, which further comprises:
a second interlayer formed on the second recording film and made of a transparent resin material having a groove and land with said one of the concentric shape and the spiral shape; and
a third recording film formed on the groove and land of the second interlayer, and
in which a light reflectance of the recording mark formed in the third recording film by irradiation with the short-wavelength laser beam is lower than a light reflectance before irradiation with the short-wavelength laser beam.

4. A medium according to claim 1, wherein the recording films contain an organic dye.

5. A write once information recording medium comprising:
a transparent resin substrate having a groove and land with one of a concentric shape and a spiral shape;
a first recording film formed on the groove and land of the transparent resin substrate;
a first interlayer formed on the first recording film and made of a transparent resin material having a groove and land with said one of the concentric shape and the spiral shape;
a second recording film formed on the groove and land of the first interlayer;
a second interlayer formed on the second recording film and made of a transparent resin material having a groove and land with said one of the concentric shape and the spiral shape; and
a third recording film formed on the groove and land of the second interlayer,
wherein a recording mark is formed in the first recording film, the second recording film, and the third recording film by irradiation with a short-wavelength laser beam,
a light reflectance of the recording mark formed in the first recording film by irradiation with the short-wavelength laser beam is higher than a light reflectance before irradiation with the short-wavelength laser beam,
a light reflectance of the recording mark formed in the second recording film by irradiation with the short-wavelength laser beam is higher than a light reflectance before irradiation with the short-wavelength laser beam,
a light reflectance of the recording mark formed in the third recording film by irradiation with the short-wavelength laser beam is lower than a light reflectance before irradiation with the short-wavelength laser beam, and
the groove wobbles within a predetermined amplitude range.

6. A medium according to claim 5, wherein the recording films contain an organic dye.

7. A disk apparatus for playing back a write once information recording medium comprising a transparent resin substrate having a groove and land with one of a concentric shape and a spiral shape, a first recording film formed on the groove and land of the transparent resin substrate, an interlayer formed on the first recording film and made of a transparent resin material having a groove and land with said one of the concentric shape and the spiral shape, and a second recording film formed on the groove and land of the interlayer,
wherein a recording mark is formed in the first recording film and the second recording film by irradiation with a short-wavelength laser beam,
a light reflectance of the recording mark formed in the first recording film by irradiation with the short-wavelength laser beam is higher than a light reflectance before irradiation with the short-wavelength laser beam,
a light reflectance of the recording mark formed in the second recording film by irradiation with the short-wavelength laser beam is lower than a light reflectance before irradiation with the short-wavelength laser beam, and
the groove wobbles within a predetermined amplitude range.

8. An apparatus according to claim 7, wherein
the write once information recording medium further comprises a second interlayer formed on the second recording film and made of a transparent resin material having a groove and land with said one of the concentric shape and the spiral shape, and a third recording film formed on the groove and land of the second interlayer, and
a light reflectance of the recording mark formed in the third recording film by irradiation with the short-wavelength laser beam is higher than a light reflectance before irradiation with the short-wavelength laser beam.

9. An apparatus according to claim 7, wherein
the write once information recording medium further comprises a second interlayer formed on the second recording film and made of a transparent resin material having a groove and land with said one of the concentric shape and the spiral shape, and a third recording film formed on the groove and land of the second interlayer, and
a light reflectance of the recording mark formed in the third recording film by irradiation with the short-wavelength laser beam is lower than a light reflectance before irradiation with the short-wavelength laser beam.

10. An apparatus according to claim 7, wherein the recording films contain an organic dye.

11. A disk apparatus for playing back a write once information recording medium comprising a transparent resin substrate having a groove and land with one of a concentric shape and a spiral shape, a first recording film formed on the groove and land of the transparent resin substrate, a first interlayer formed on the first recording film and made of a transparent resin material having a groove and land with said one of the concentric shape and the spiral shape, a second recording film formed on the groove and land of the first interlayer, a second interlayer formed on the second recording film and made of a transparent resin material having a groove and land with said one of the concentric shape and the spiral shape, and a third recording film formed on the groove and land of the second interlayer,
wherein a recording mark is formed in the first recording film, the second recording film, and the third recording film by irradiation with a short-wavelength laser beam,
a light reflectance of the recording mark formed in the first recording film by irradiation with the short-wavelength laser beam is higher than a light reflectance before irradiation with the short-wavelength laser beam,
a light reflectance of the recording mark formed in the second recording film by irradiation with the short-wavelength laser beam is higher than a light reflectance before irradiation with the short-wavelength laser beam,
a light reflectance of the recording mark formed in the third recording film by irradiation with the short-wavelength laser beam is lower than a light reflectance before irradiation with the short-wavelength laser beam, and
the groove wobbles within a predetermined amplitude range.

12. An apparatus according to claim 11, wherein the recording films contain an organic dye.
